(19) United States
(12) Patent Application Publication
(10) Pub. No.: US 2010/0128058 A1
(43) Pub. Date: May 27, 2010

(54) IMAGE VIEWING APPARATUS AND METHOD

(76) Inventors: Akihiro Kawabata, Osaka (JP); Meiko Maeda, Kanagawa (JP); Takashi Kawamura, Kyoto (JP); Kuniaki Isogai, Osaka (JP); Ryouichi Kawanishi, Osaka (JP); Katsunao Takahashi, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/530,004

(22) PCT Filed: Mar. 21, 2008
(86) PCT No.: PCT/JP2008/000669

§ 371 Date: Sep. 4, 2009

(30) Foreign Application Priority Data
Mar. 27, 2007 (JP) 2007-080829

(51) Int. Cl. G09G 5/02

(52) U.S. Cl. 345/593; 382/165

(57) ABSTRACT

Image browsing device and method for displaying a list so that the viewers can efficiently grasp the contents of a lot of images. The image browsing device includes an image classifying unit, a representative color extracting unit, and a representative color layout unit, and further includes a shooting date/time obtaining unit, an ordinary/extraordinary setting unit, a display mode managing unit, a representative color switching unit and the like. The image browsing device, with this structure, extracts a representative color for each image group which has been obtained by classifying images in accordance with a predetermined criterion, so that the representative color represents the image group. This enables viewers to grasp efficiently and panoramically the contents of a large number of images which are displayed in a display area of a limited size.

### TECHNICAL FIELD

The present invention relates to image browsing device and method for displaying a list so that the viewers can grasp the contents of a lot of images.

### BACKGROUND ART

As digital cameras and mobile phones with camera function have become prevalent, more and more digital images have been shot. Also, the recording media for storing digital images have become larger in capacity. With such progresses, a large amount of images can be shot and stored in a device.

Furthermore, in recent years, use of wearable cameras has been studied in recording personal experiences in the forms of still and moving pictures. The wearable cameras can shoot images at regular intervals, for example, once every one minute. The number of images recorded at such a pace would be enormous.

Meanwhile, one of conventional methods for displaying a lot of images at once on a screen is a thumbnail display in which a lot of thumbnail images are displayed on the screen. Also, there has been proposed a device which has a function developed from the thumbnail display (see Patent Document 1 identified below).

In the device disclosed in Patent Document 1, a time axis is displayed together with a list of thumbnail images, and with a specification of a range on the time axis, only the images belonging to the specified range are displayed as a list of thumbnail images. Also, a representative color is assigned to each section that has a predetermined number of images on the time axis so that each section can be distinguished from the other sections.

Patent Document 1: Japanese Patent Application Publication No. 2006-244051.

### DISCLOSURE OF THE INVENTION

### The Problems the Invention is Going to Solve

However, the conventional image browsing technology has a problem when contents of a lot of images are to be grasped at once in the above-mentioned situation in which a large amount of images are shot and stored.

That is to say, when a lot of thumbnail images are to be displayed at once for browsing, each thumbnail image should be reduced to be very small in size so that all images can be displayed in a display area that is limited in size. This results in the difficulty in grasping the contents of the images. Conversely, when the thumbnail images are displayed in such a size suitable for grasping the contents of the images, all images cannot be displayed in the display area. This results in decrease in listing the whole images.

Here, the range specification technology disclosed in Patent Document 1 might be applied to reduce the number of images to be displayed. This, however, would result in the same problem when, for example, the above-mentioned wearable camera is used to keep shooting images at regular intervals to store a lot of images in a predetermined period.

Also, when the representative color is assigned to each section that has a predetermined number of images on the time axis, as disclosed in Patent Document 1, an effect of making it easy to grasp the contents of images on the whole time axis would be obtained. However, with this technology, since representative colors align on the time axis and sections are determined based on a predetermined number of images, it is difficult to grasp the contents of images for each particular period, such as each year. Furthermore, while displaying the representative colors produces an advantageous effect of making it easy to roughly grasp the contents of images, it creates lack of information because a plurality of images are represented by a single color. Namely, in the technology in which one representative color is simply displayed for each section on the time axis, the amount of information that can be represented is limited.

It is therefore an object of the present invention to provide image browsing device and method for displaying a list so that the viewers can efficiently grasp the contents of a lot of images.

### Means to Solve the Problems

The above-described object is fulfilled by an image browsing device comprising: an image obtaining unit operable to obtain a plurality of shot images; an image classifying unit operable to classify the obtained shot images into a plurality of image groups according to a shooting time of each image such that images shot in a same period belong to a same image group; a color extracting unit operable to extract, for each of the plurality of image groups, one or more representative colors representing the each of the plurality of image groups; a color layout unit operable to lay out the extracted one or more representative colors, on a browsing screen at positions that are determined from periods corresponding to the representative colors; and a screen display unit operable to display the browsing screen with the representative colors laid out thereon.

### EFFECTS OF THE INVENTION

With the above-described structure, it is possible to classify a plurality of images into image groups each having a predetermined period, according to the shooting dates/times of the images, and lay out the representative colors in correspondence with the periods. This produces an advantageous effect that it is easy for users to grasp the change in contents of images for each particular period, such as each year.

In the above-stated image browsing device, the browsing screen may have a coordinate plane which is composed of a first axis and a second axis, the first axis corresponding to elapse of time in first time units, the second axis corresponding to elapse of time in second time units, the second time unit being obtained by segmentation of the first time unit, and the color layout unit lays out the one or more representative colors in a region on the coordinate plane, the region corresponding to a first time unit to which the period corresponding to the representative color belongs, at a position corresponding to a second time unit to which the period belongs.

The above-described structure, in which the representative colors are laid out on a coordinate plane which is composed of a first axis and a second axis, produces an advantageous effect that it is possible for users to grasp more easily the change in contents of images for each particular period.

In the above-stated image browsing device, whether an image was shot in an ordinary state or in an extraordinary state may have been set in each image obtained by the image obtaining unit, and the color extracting unit extracts the one or more representative colors from either or both of images shot in the ordinary state and images shot in the extraordinary state, among images included in each image group.

With the above-described structure in which each image is set to either ordinary or extraordinary which respectively indicate that the image was shot in the ordinary state or in the extraordinary state, and the representative colors can be extracted from only images that have been set to either of the ordinary and the extraordinary, viewers can easily grasp the contents of images panoramically on whether they are of the normal trend or in the special case.

In the above-stated image browsing device, the color extracting unit may extract the one or more representative colors from only images shot in the extraordinary state.

With the above-described structure in which each image is set to either ordinary or extraordinary which respectively indicate that the image was shot in the ordinary state or in the extraordinary state, and the representative colors can be extracted from only images that have been set to the extraordinary, viewers can easily grasp the contents of images in the special case panoramically.

In the above-stated image browsing device, the color extracting unit may extract a first representative color from images shot in the ordinary state, and extract a second representative color from images shot in the extraordinary state, and the color layout unit lays out the first and second representative colors on the browsing screen by applying the first and second representative colors separately at the position.

With the above-described structure in which the first and second representative colors are displayed separately, viewers can easily grasp the contents of images with distinction between the normal case and the special case.

In the above-stated image browsing device, the color extracting unit may extract a first representative color from images shot in the ordinary state, and extract a second representative color from images shot in the extraordinary state, and the color layout unit lays out the first representative color and the second representative color one at a time on the browsing screen by switching therebetween at the position.

With the above-described structure in which the first and second representative colors are displayed separately, viewers can easily grasp the contents of images with distinction between the normal case and the special case.

In the above-stated image browsing device, the color extracting unit may include: a storage unit storing one of a plurality of display modes which respectively indicate a plurality of methods of arranging and displaying each image; a switching unit operable to switch between methods of determining representative colors depending on the display mode stored in the storage unit; and an extracting unit operable to extract the one or more representative colors for each image group depending on a method of determining representative colors that has been set as a result of the switching performed by the switching unit.

With the above-described structure where the methods of determining the representative colors are switched depending on the switch between the image display modes, appropriate representative colors that are suited to the browsing state can be displayed.

In the above-stated image browsing device, one of the plurality of methods of arranging and displaying each image may be a method by which images are arranged and displayed based on a time axis, and another one of the plurality of methods of arranging and displaying each image may be a method by which images are arranged and displayed based on additional information associated with the images, the storage unit stores one of a first display mode and a second display mode, wherein in the first display mode, images are laid out and displayed based on the time axis, and in the second display mode, images are laid out and displayed based on the additional information associated with the images, the switching unit in the first display mode switches to a method of determining, as the one or more representative colors, one or more colors that correspond to a largest number of pieces of additional information among images constituting an image group, and in the second display mode switches to a method of determining, as the one or more representative colors, a color that is a main color among the images constituting the image group, and the extracting unit extracts the one or more representative colors by the method of determining a color that corresponds to additional information, or by the method of determining a color that is a main color among the images constituting the image group.

With the above-described structure where the two modes (a first mode in which images are arranged and displayed based on a time axis; and a second mode in which images are arranged and displayed based on additional information associated with the images) are switched, appropriate representative colors that are suited to the browsing state can be displayed.

In the above-stated image browsing device, the color extracting unit may extract, as the one or more representative colors, a main color of images targeted for extracting representative colors among the images constituting the image group.

With the above-described structure where each displayed representative color is a main color of target images, viewers can easily grasp the contents of the target images.

In the above-stated image browsing device, each image obtained by the image obtaining unit may be associated with additional information, the image browsing device further comprises: a storage unit storing the additional information and colors associated therewith, and the color extracting unit extracts, as the one or more representative colors, a color that is associated with a largest number of pieces of additional information, among images targeted for extracting representative colors among the images constituting the image group.

With the above-described structure where each extracted representative color is a color that corresponds to additional information associated with a largest number of images targeted for extracting the representative color, among images constituting an image group, viewers can easily grasp the contents of the target images.

In the above-stated image browsing device, the color extracting unit may extract, as representative colors, a plurality of colors in correspondence with a plurality of conditions, and the color layout unit lays out the representative colors by applying the representative colors separately.

With the above-described structure in which a plurality of representative colors corresponding to a plurality of conditions are extracted and displayed separately, it is possible to, while representing a lot of images by colors, display a larger amount of information than the case where a piece of information is simply represented by a single color.

In the above-stated image browsing device, the color layout unit may lay out the representative colors by applying the representative colors separately at the position, in accordance with a ratio of the number of images among images which respectively satisfy the plurality of conditions, among the images included in the image group.

In the above-stated image browsing device, the color layout unit may lay out the representative colors by applying the representative colors separately such that the representative colors gradually change from a first color to a second color among the plurality of representative colors, and adjust a level of the gradual change of the colors depending on a distribution of the images which respectively satisfy the plurality of conditions.

In the above-stated image browsing device, the color layout unit may change patterns of applying separately the plurality of representative colors, depending on a distribution of the images which respectively satisfy the plurality of conditions, among the images included in the image group.

In the above-stated image browsing device, the color extracting unit may extract, as the one or more representative colors, a plurality of colors which respectively satisfy a plurality of conditions, and the color layout unit lays out the plurality of representative colors one at a time by switching thereamong.

With the above-described structure in which a plurality of representative colors corresponding to a plurality of conditions are extracted and displayed by switching therebetween, it is possible to, while representing a lot of images by colors, display a larger amount of information than the case where a piece of information is simply represented by a single color.

In the above-stated image browsing device, the color layout unit may change patterns of applying the plurality of representative colors by switching, depending on a distribution of the images which respectively satisfy the plurality of conditions, among the images included in the image group.

In the above-stated image browsing device, the color extracting unit may extract the representative colors by generating representative colors by assigning each of the plurality of pieces of information regarding the image groups to different color components of a predetermined color system.

With the above-described structure in which representative colors are generated and displayed by assigning each of the plurality of pieces of information regarding the image groups to different color components of a predetermined color system, it is possible to, while representing a lot of images by colors, display a larger amount of information than the case where apiece of information is simply represented by a single color.

In the above-stated image browsing device, the predetermined color system may be a color system composed of hue, luminance, and saturation, and the color extracting unit extracts the representative colors by generating representative colors by assigning each of the plurality of pieces of information regarding the image groups to hue, luminance, and saturation.

The above-stated image browsing device may further comprise: an image generating unit operable to generate reduced images by reducing each of the obtained plurality of images; an image layout unit operable to lay out the generated reduced images on the browsing screen; a range setting unit operable to set a browsing range that indicates a range of images being targets of browsing; and a layout switching unit operable to switch between a layout by the color layout unit and a layout by the image layout unit, by using the browsing range set by the range setting unit, wherein the screen display unit display the browsing screen with a layout set by the layout switching unit.

With the structure where the browsing targets, namely, the display of representative colors and the display of reduced images are switched, it is possible for users to browse images with a more appropriate display reflecting the amount of browsing-target images.

In the above-stated image browsing device, the layout switching unit may switch between the layout by the color layout unit and the layout by the image layout unit, depending on whether the number of images included in the browsing range set by the range setting unit is equal to or smaller than a predetermined number.

In the above-stated image browsing device, the layout switching unit may switch between the layout by the color layout unit and the layout by the image layout unit, depending on whether the shooting dates and times of images included in the browsing range set by the range setting unit are included in a predetermined time period.

As described above, according to the image browsing device and method of the present invention, viewers can grasp efficiently and panoramically the contents of a large number of images which are displayed in a display area of a limited size.

### BRIEF DESCRIPTION OF THE DRAWING

FIG. 1 shows the structure of an image browsing device 1 in Embodiment 1 of the present invention.

FIG. 2A shows a color correlation table A 300 indicating one example of relationships between colors and tags managed by the color correlation managing unit.

FIG. 2B shows a color correlation table B 310 indicating one example of relationships between colors and tags managed by the color correlation managing unit.

FIG. 3 shows an example case in which representative colors are laid out, with the vertical axis set to represent years, the horizontal axis set to represent months.

FIG. 4 shows an example case in which representative colors are laid out, with the vertical axis set to represent weeks, the horizontal axis set to represent days of week.

FIG. 5 shows examples of combinations of the time period of image classification, time unit represented by the vertical axis, and time unit represented by the horizontal axis.

FIGS. 6A through 6B show examples of screen display modes in which images are laid out on a time axis.

FIG. 6A shows a thumbnail list screen 350 in which thumbnail images are displayed in bulk for each month.

FIG. 6B shows a representative color list screen 360 in which representative colors of 10 years are displayed, with the predetermined time period being set to one month.

FIGS. 7A through 7B show examples of screen displays where images are arranged based on the tags associated with the images.

FIG. 7A shows a thumbnail list screen 370 in which thumbnail images are displayed in bulk for each tag associated with the images.

FIG. 7B shows a representative color list screen 380 in which representative colors of one year are displayed in bulk for each tag associated with the images.

FIGS. 8A through 8D show examples of applying representative colors separately.

FIG. 8A shows an example of a layout in which the subject representative color and the background representative color are applied separately inside and outside the subject representative color region 392.

FIG. 8B shows an example of a layout in which the representative color for ordinary-state image and the representative color for extraordinary-state image are applied separately.

FIG. 8C shows an example of a layout in which the representative color for extraordinary-state image is dispersed.

FIG. 8D shows an example of a layout in which the representative color for extraordinary-state image is laid out in concentration.

FIG. 9 shows the structure of an image browsing device 2 in Embodiment 2 of the present invention.

FIG. 10 shows the structure of an image browsing system 6 in Embodiment 3 of the present invention.

FIG. 11 shows an example of the data structure of a plurality of image files 61, 62, 63, . . . , 64 stored in the storage unit 52.

FIGS. 12A through 12F show six types of classification keys stored in the storage unit 52.

FIGS. 13A through 13B show examples of the axis information stored in the storage unit 52.

FIGS. 14A through 14E show examples of the operation patterns stored in the storage unit 52.

FIG. 15 shows an example of the browsing range information stored in the storage unit 52.

FIGS. 16A through 16B show examples of the display modes stored in the storage unit 52.

FIGS. 17A through 17D show examples of the separation types stored in the storage unit 52.

FIGS. 18A through 18B show examples of the browsing modes stored in the storage unit 52.

FIG. 19 shows an example of the data structure of the classification table.

FIG. 20 shows the data structure of the classification table A 490 as one example of classification table.

FIG. 21 shows the data structure of the classification table B 500 as one example of classification table.

FIG. 22 shows one example of the data structure of color table.

FIG. 23 shows the data structure of the color table A 510 as one example of color table.

FIG. 24 shows the data structure of the color table B 520 as one example of color table.

FIG. 25 shows the data structure of the color table C 530 as one example of color table.

FIG. 26 shows the data structure of the color table D 540 as one example of color table.

FIG. 27 shows a list screen 550 when the method shown in FIG. 8B is applied to the representative color list screen 330.

FIG. 28 shows a list screen 560 when the method shown in FIG. 8A is applied to the representative color list screen 320.

FIG. 29 shows a list screen 570 when the method shown in FIGS. 8C through 8D is applied to the representative color list screen 320.

FIGS. 30A through 30D show examples of applying representative colors separately.

FIG. 30A shows an example in which, when applying the representative colors separately for the images shot in the ordinary state and the images shot in the extraordinary state, the colors are changed gradually from the first representative color to the second representative color by gradation.

FIG. 30B shows an example in which, when the representative colors are applied separately so that the colors change gradually from the representative color for the images shot in the ordinary state to the representative color for the images shot in the extraordinary state, the level of gradation is determined based on whether the change from the representative color for the images shot in the ordinary state to the representative color for the images shot in the extraordinary state is gentle or steep.

FIG. 30C shows an example of a layout in which, when applying the representative colors separately for the subject and the background, the colors are changed gradually from the first representative color to the second representative color by gradation.

FIG. 30D shows an example in which, when the representative colors are applied separately so that the colors change gradually from the subject representative color to the background representative color, the level of gradation is varied.

FIG. 31 is a flowchart showing the general operation of the image browsing device 4.

FIG. 32 is a flowchart showing the operation of the setting process.

FIG. 33 is a flowchart showing the operation of the browsing mode selecting process.

FIG. 34 is a flowchart showing the operation of classifying image files.

FIG. 35 is a flowchart showing the operation of extracting representative colors.

FIG. 36 is a flowchart showing the operation of extracting representative colors from the image data.

FIG. 37 is a flowchart showing the operation of determining representative colors from tags.

FIG. 38 is a flowchart showing the operation of extracting representative colors from the extraordinary image data.

FIG. 39 is a flowchart showing the operation of extracting representative colors from each of ordinary and extraordinary image data.

FIG. 40 is a flowchart showing the operation of extracting representative colors from image data for each of subject and background.

FIG. 41 is a flowchart showing the operation of laying out representative colors, continued to FIG. 42.

FIG. 42 is a flowchart showing the operation of laying out representative colors, continued from FIG. 41.

FIG. 43 is a flowchart showing the operation of applying representative colors separately.

### DESCRIPTION OF CHARACTERS

1 image browsing device
2 image browsing device
4 image browsing device
5 recording device
6 image browsing system
10 image classifying unit
11 representative color extracting unit
12 representative color layout unit
13 shooting date/time obtaining unit
14 ordinary/extraordinary setting unit
15 display mode managing unit
16 representative color switching unit
17 display unit
18 input/output unit
19 storage unit
20 reduced image generating unit
21 reduced image layout unit
30 browsing range setting unit
31 browsing mode switching unit
32 information setting unit
51 input/output unit
52 storage unit
100 representative color display unit
101 reduced image display unit

### BEST MODE FOR CARRYING OUT THE INVENTION

The following describes the embodiments of the present invention with reference to the attached drawings.

### 1. EMBODIMENT 1

### (1) Structure of Image Browsing Device 1

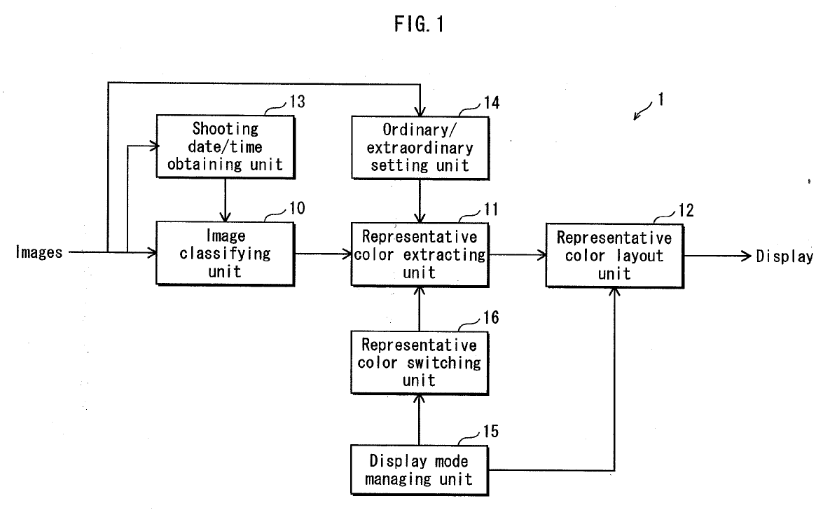

FIG. 1 shows the structure of an image browsing device 1 in Embodiment 1 of the present invention.

The image browsing device 1, as shown in FIG. 1, includes an image classifying unit 10, a representative color extracting unit 11, a representative color layout unit 12, a shooting date/time obtaining unit 13, an ordinary/extraordinary setting unit 14, a display mode managing unit 15, and a representative color switching unit 16. This device is, for example, a portable information terminal device.

The image browsing device 1 is specifically a computer system that includes a microprocessor, ROM, RAM, a hard disk unit, a liquid crystal display unit, a keyboard and the like. A computer program is stored in the RAM or the hard disk unit. The microprocessor operates in accordance with the computer program and the image browsing device 1 achieves its functions.

### (2) Basic Operation of Image Browsing Device 1

The basic operation of the image browsing device 1 is described in the following.

The image browsing device 1 reads out a plurality of image files from a recording device. First, the image classifying unit 10 classifies the read-out plurality of image files into one or more image groups based on a predetermined criterion. Next, the representative color extracting unit 11 extracts a representative color for each of the image groups obtained by the image classifying unit 10, the representative color indicating a characteristic of the image group. The representative color layout unit 12 lays out the representative colors and displays the laid-out colors.

Here, the representative color extracting unit 11 determines, as the representative color, the most main color of the images included in the image group, namely, a color that is occupying a widest region in the images. More specifically, it determines a color that is occupying a widest region among the colors included in all the images in the whole image group. In another example, first, a main color may be determined for each image included in the image group, and then with respect to each main color, the number of images whose main colors are the same may be counted, and a color that is a main color of the largest number of images in the group may be determined as the main color of the whole image group. Note that the method for determining the main color is not limited to these.

### (3) Use of Tag

The image browsing device 1 may use, as the method for determining the main color, a method of using a tag (additional information) that is correlated with an image. For example, information embedded in Exif (Exchangeable Image File Format) format image files may be used as the tag. Also, information that is managed by a database different from the database managing the image files may be used as the tag.

In this case, the image browsing device 1 is further provided with a color correlation managing unit (its illustration omitted in FIG. 1) that manages tags and colors by correlating them with each other, and the representative color extracting unit 11 may determine, as the representative color, a color corresponding to a tag content that is associated with the largest number of images in the image group. More specifically, the representative color extracting unit 11 may count, for each tag content, the number of images that correspond to a same tag content in the whole image group, determine a tag content that is associated with the largest number of images in the image group, and then determine a color correlated with the determined tag content, as the representative color.

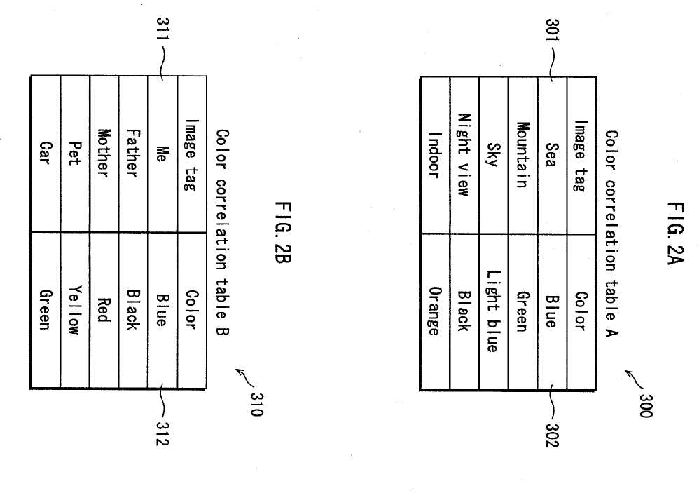

FIGS. 2A and 2B show an example of correlation relationships between tag contents and colors managed by the color correlation managing unit. The color correlation managing unit, for example, a color correlation table A 300 shown in FIG. 2A or a color correlation table B 310 shown in FIG. 2B.

In this example, FIG. 2A shows relationships between tag contents and colors, where tags representing subjects are respectively correlated with colors that are suggested from the subjects; and FIG. 2B shows relationships that are irrelevant with such suggestion of colors.

In the color correlation table A 300 shown in FIG. 2A, an image tag “sea” 301 is correlated with a color “blue” 302. Similarly, image tags “mountain”, “sky”, “night view”, and “indoor” are correlated with colors “green”, “light blue”, “black”, and “orange”, respectively. Also, in the color correlation table B 310 shown in FIG. 2B, an image tag “me” 311 is correlated with a color “blue” 312. Similarly, image tags “father”, “mother”, “pet”, and “car” are correlated with colors “black”, “red”, “yellow”, and “green”, respectively.

Note that the method for managing the relationships between tags and colors is not limited to the above-described ones.

### (4) Classifying Images Based on Shooting Date/Time

Here will be described a case where the image browsing device 1 of the present invention classifies a plurality of images based on the shooting date/time information that is embedded in the image files or recorded in correspondence with the image files, and extracts and displays representative colors.

As the shooting date/time information, information embedded in the image files of the Exif format can be used, for example.

First, the shooting date/time obtaining unit 13 obtains the shooting date/time (year, month, day, hour, minute, and second) of each image. The image classifying unit 10 then classifies a plurality of images into a plurality of image groups based on the obtained shooting date/time. For example, the image classifying unit 10 classifies a plurality of images based on the year and month included in the shooting date/time information.

Next, the representative color extracting unit 11 extracts representative colors of the respective image groups for each time period. The representative color layout unit 12 lays out the representative colors in correspondence with the time periods and displays the laid-out colors. In so doing, the representative color layout unit 12 may lay out the representative colors two-dimensionally, with a vertical axis and a horizontal axis being respectively associated with an upper time unit and a lower time unit. Here, as one example, the upper time unit is year and the lower time unit is month. As another example, the upper time unit is year-month and the lower time unit is day. Also, the representative color layout unit 12 may lay out the representative colors for each month two dimensionally such that the vertical axis represents a plurality of years in time sequence, and the horizontal axis represents 12 months in time sequence. Here, each region in which a representative color is laid out is referred to as a display unit region. Also, the lower time unit is obtained by segmentation of the upper time unit.

As a further example, the horizontal axis may represent a plurality of years in time sequence, and the vertical axis may represent 12 months in time sequence.

The above explanation can be summarized as follows. That is to say, the browsing screen in which the representative colors are laid out includes a coordinate plane composed of a first axis and a second axis. The first axis corresponds to the passing of time in the first time unit, and the second axis corresponds to the passing of time in the second time unit which is obtained by segmentation of the first time unit.

The representative color layout unit 12 lays out a representative color in the coordinate plane. More specifically, it lays out the representative color at a position corresponding to a second time unit, the position being included in a region corresponding to a first time unit to which a time period corresponding to the representative color belongs.

Here, the first axis is the vertical axis and the second axis is the horizontal axis; or the first axis is the horizontal axis and the second axis is the vertical axis. The first time unit is the above-mentioned upper time unit, and the second time unit is the above-mentioned lower time unit.

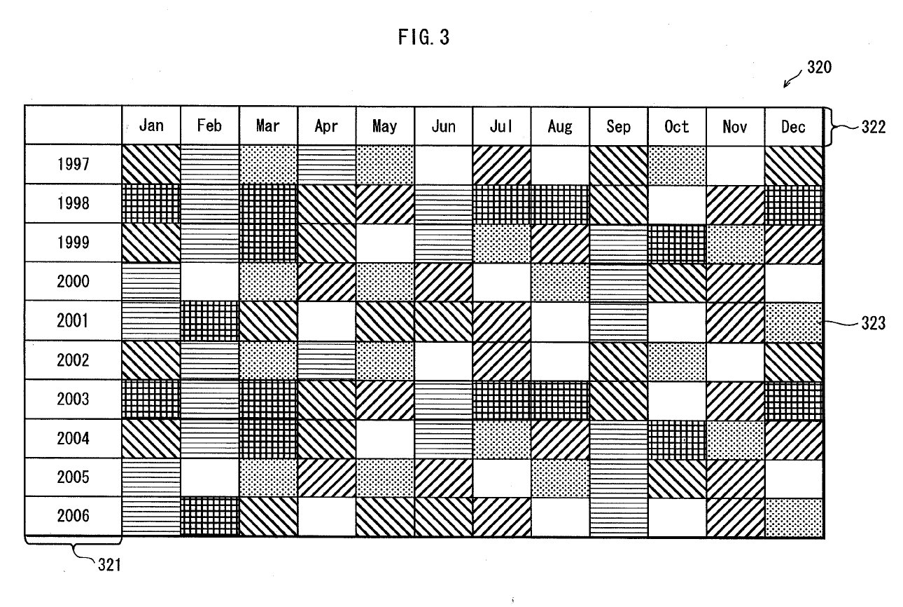

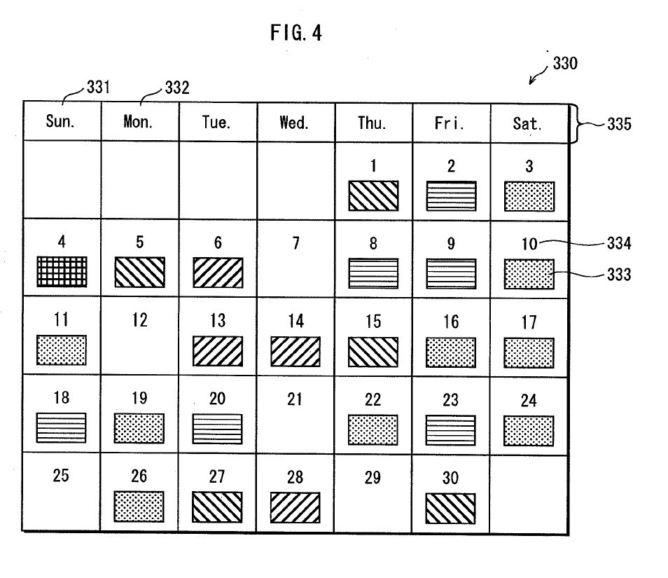

FIGS. 3 and 4 show examples in which images are classified into image groups of a predetermined time period based on the shooting date/time, a representative color is extracted from each of the image groups, the vertical and horizontal axes are respectively set to represent the upper and lower time units, and the representative colors are laid out two dimensionally. It is presumed for the sake of convenience that in FIGS. 3 and 4, the various patterns filling the display unit regions respectively indicate different colors.

FIG. 3 shows an example case in which images are classified into image groups each belonging to one month, a representative color is extracted from each image group, the vertical axis is set to represent years, the horizontal axis is set to represent months, and the representative colors are laid out.

FIG. 4 shows an example case in which images are classified into image groups each belonging to one day, a representative color is extracted from each image group, the vertical axis is set to represent weeks, the horizontal axis is set to represent days of the week, and the representative colors are laid out.

In the example shown in FIG. 3, the trend of the images shot over 10 years can be browsed by the representative colors. If the images were shot at a rate of 500 images per month, the total number of images shot would be 60,000 in 10 years. Apparently, the 60,000 images could not be displayed at once by the thumbnail display. However, the image browsing device 1 of the present invention enables the trend of the images to be grasped at once.

Furthermore, in the example shown in FIG. 3, the vertical axis represents years, and the horizontal axis represents months. This makes it possible to grasp the changes over the years at once by comparing the representative colors in the vertical direction.

When the images are shot at regular intervals by using a wearable camera, a large amount of images are accumulated in a short time period. Even in such a case, the image browsing device 1 of the present invention enables the trend of the images in a predetermined time period to be grasped at once effectively, as shown in FIG. 4.

As shown in FIG. 5, the time period of image classification, time unit represented by the vertical axis, and time unit represented by the horizontal axis can be combined in various ways, as well as being combined in the above-described ways. The image browsing device 1 can use such combinations. It should be noted here that the time period of image classification is a minimum unit time that is used as a classification key when images are classified based on the shooting date/time. It is presumed that all images corresponding to a shooting date/time included in the minimum unit time are classified as belonging to the same group, namely the same image group.

As shown in FIG. 5, (i) the time period of image classification may be set to “month”, the time unit of vertical axis to “year”, and the time unit of horizontal axis to “month”; (ii) the time period of image classification may be set to “week”, the time unit of vertical axis to “year”, and the time unit of horizontal axis to “week”; (iii) the time period of image classification may be set to “day”, the time unit of vertical axis to “month”, and the time unit of horizontal axis to “day”; (iv) the time period of image classification may be set to “day”, the time unit of vertical axis to “week”, and the time unit of horizontal axis to “day of week”; or (v) the time period of image classification may be set to “time”, the time unit of vertical axis to “day”, and the time unit of horizontal axis to “time”. However, the present invention is not limited to these.

### (5) Distinction Between Ordinary and Extraordinary

Now description is given of a case where the image browsing device 1 of the present invention sets each image to the ordinary or the extraordinary, indicating the state in which the image was shot, and representative colors are extracted from images of either the ordinary or the extraordinary. Here, one example of the ordinary is commuting to/from the workplace or school, and one example of the extraordinary is making a trip.

First, in accordance with the operation of the user, the ordinary/extraordinary setting unit 14 sets in each image a distinction between the ordinary state, such as commuting to/from the workplace or school, or the extraordinary state, such as making a trip, in which the image was shot. Note that, not limited to the structure where the distinction is set in each image in accordance with the operation of the user, the ordinary/extraordinary setting unit 14 may set in each image an indication of the ordinary in the case where the image was shot on a weekday (one of Monday to Friday), and may set in each image an indication of the extraordinary in the case where the image was shot on a holiday (one of Saturday, Sunday, and a public holiday).

Next, the representative color extracting unit 11 extracts representative colors from each image group composed of images having been set as either the ordinary or the extraordinary.

Here, the operation of the representative color extracting unit 11 and the representative color layout unit 12 can be classified into several patterns. The following describes the patterns.

(a) In the first operation pattern, the representative color extracting unit 11 extracts representative colors from images having been set as the extraordinary. Next, the representative color layout unit 12 lays out and displays the representative colors extracted from images having been set as the extraordinary.

With the above-described structure, the trend of the image groups can be grasped more effectively by browsing the representative colors of the special-case images shot in an extraordinary state.

This method is useful especially in the case where images are shot at regular intervals by using a wearable camera, images shot in an extraordinary state are likely to be buried in a large amount of images shot in an ordinary state.

(b) In the second operation pattern, the representative color extracting unit 11 extracts representative colors from both images having been set as the ordinary and the extraordinary. Next, the representative color layout unit 12 lays out and displays the representative colors with distinction between the ordinary and the extraordinary in a same display unit region.

(c) In the third operation pattern, the representative color extracting unit 11 extracts representative colors from both images having been set as the ordinary and the extraordinary. Next, the representative color layout unit 12, in accordance with the operation of the user, lays out and display the representative colors by switching between the ordinary and the extraordinary.

The second and third operation patterns enable a user to browse the representative colors in comparison between the ordinary and extraordinary states in which the images were shot. This makes it possible for the user to grasp more efficiently the respective trends in the ordinary and extraordinary states by browsing the list.

Furthermore, the representative colors may be applied separately for the ordinary and extraordinary states in accordance with the ratio in number between the images shot in the ordinary state and the images shot in the extraordinary state. This method is especially useful when images are shot at regular intervals using a wearable camera because it is possible to grasp at once the ratio between the images shot in the ordinary state and the images shot in the extraordinary state.

Note that the present invention is not limited to the above-described methods for setting each image to the ordinary or the extraordinary. For example, the setting may be done manually or detected automatically by a predetermined method.

Also, an indication of the ordinary or the extraordinary may be set in each image group, not in each image. This case is equivalent with a case where all images included in a same image group are set as either the ordinary or the extraordinary. For example, when the images are classified based on the shooting date, image groups classified as belonging to one of Saturday, Sunday, and a public holiday may be set as the extraordinary, and the remaining image groups may be set as the ordinary. The following structure is also available. That is to say, location information indicating the location of the shooting is attached to each image file as well as the shooting date/time, the images are classified based on the shooting date and the location information, image groups classified as belonging to one of Saturday, Sunday, and a public holiday and a predetermined location are set as the extraordinary, and the remaining image groups are set as the ordinary. Here, the predetermined location is, for example, a location of an amusement park or a sightseeing spot.

Further, a process may be added such that when representative colors are to be extracted from the images having been set as the extraordinary, if an image group does not include any image having been set as the extraordinary, representative colors are extracted from the images having been set as the ordinary in the image group, instead of the images having been set as the extraordinary. In this case, a message or the like that indicates the fact may be displayed as well.

### (6) Switching Display Mode

Now description is given of a case where the image browsing device 1 of the present invention switches the method for determining the representative color each time the display mode is switched.

The display mode managing unit 15 sets and manages the switching between display modes, where the display modes indicate how the images should be laid out and displayed. The display modes and examples of screen displays thereof will be described later.

When the display mode managing unit 15 sets the display mode, the representative color switching unit 16 switches the method for determining the representative color, in accordance with the display mode set by the display mode managing unit 15.

Next, the representative color extracting unit 11 extracts representative colors according to the representative color determination method set by the representative color switching unit 16 by switching.

Lastly, the representative color layout unit 12 displays the representative colors in a layout corresponding to the display mode.

As one example of display mode, images are laid out on a time axis. As another example of display mode, images are laid out based on the tags (additional information) whose contents are associated with the images. In yet another example of display mode, images are laid out based on the importance level (favorite level) set by the user. The following description centers on the former two display modes.

The display mode in which images are laid out on the time axis includes, for example: a mode in which images are displayed in alignment in the order of shooting date/time without specifying target images; and a mode in which images are displayed in bulk in correspondence with each shooting time period of a predetermined length of time.

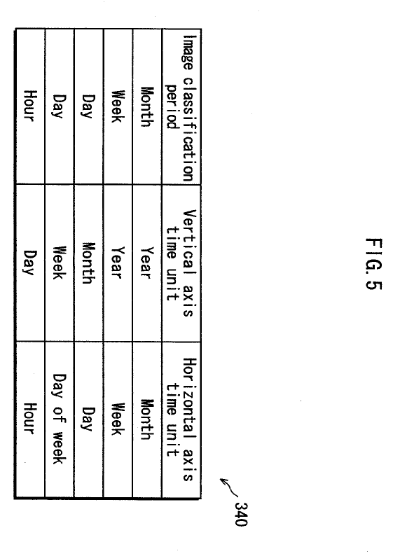

FIG. 6B shows a representative color list screen 360 as an example of the case where representative colors of 10 years are displayed, with the predetermined time period being set to one month. The representative color list screen 360 shown in FIG. 6B is the same as the representative color list screen shown in FIG. 3, but is provided here as an example case where images are classified into image groups based on the shooting date/time, a representative color is extracted from each image group, and the extracted representative colors are displayed in alignment.

FIG. 6A shows a thumbnail list screen 350 as an example of the case where thumbnail images are displayed in bulk for each month (which will be described in detail in Embodiment 2).

The display mode in which images are laid out based on the tags whose contents are associated with the images includes: a mode in which images are displayed in bulk for each content of the tags associated with the images, without specifying target images; and a mode in which representative colors are displayed in correspondence with only the images that are associated with predetermined tag contents.

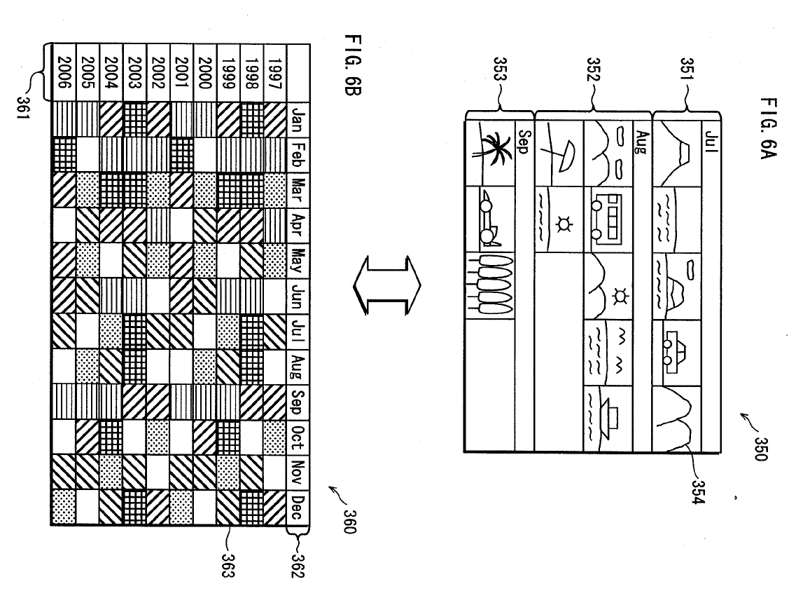

FIG. 7B shows a representative color list screen 380 as an example of the case where representative colors of one year are displayed in bulk for each tag content associated with the images. In the representative color list screen 380, the contents of the tags are shown in alignment in the vertical axis direction, and for each content of the tags, representative colors of 12 months are displayed in the horizontal axis direction, with one representative color per month. In this example, the time period of image classification is set to “month”, the unit of vertical axis is set to the tag content, and the time unit of axis is set to “month”.

FIG. 7A shows a thumbnail list screen 370 as an example of the case where thumbnail images are displayed in bulk for each tag content associated with the images (which will be described in detail in Embodiment 2).

Also, when representative colors are displayed in correspondence with only the images that are associated with predetermined tag contents, the representative colors may be extracted from only the images associated with the predetermined tag contents. In this case, the displayed screen will resemble the representative color list screen 380 shown in FIG. 7B.

In the case of a display mode in which images are laid out on a time axis, the following methods for determining the representative colors are available: a method for determining, as the representative color, the most main color of the images included in the image group; and a method for determining, as the representative color, a color corresponding to a tag content that is associated with the largest number of images in the image group. Especially, the latter method is more preferable since in this method, the tag contents directly correspond to the representative colors, and it is easier to grasp the contents of the images from the representative colors.

On the other hand, in the case of a display mode in which images are laid out based on the tags whose contents are associated with the images, the method for determining, as the representative color, a color correlated with a tag content that is associated with the largest number of images in the image group is not appropriate for use since in this case, the color correlated with the tag content is determined as the representative color, and all the determined representative colors are the same for each tag content. Accordingly, when this display mode is used, the method for determining, as the representative color, the most main color of the images included in the image group should be adopted.

In view of the above-described circumferences, the following operation of the representative color switching unit 16 is preferred: when the display mode managing unit 15 sets to the display mode in which images are laid out on a time axis, the representative color switching unit 16 switches to the method for determining, as the representative color, a color correlated with a tag content that is associated with the largest number of images in the image group; and when the display mode managing unit 15 sets to the display mode in which images are laid out based on the tags whose contents are associated with the images, the representative color switching unit 16 switches to the method for determining, as the representative color, the most main color of the images included in the image group.

### (7) Separate Application of and Switching Between Representative Colors

Next, a description is given of the case where the image browsing device 1 of the present invention extracts representative colors for each of a plurality of conditions and displays the extracted representative colors separately for each condition, and the case where the image browsing device 1 displays the extracted representative colors by switching between them for each condition.

In the following: one example of “condition” is that an image was shot in the ordinary state, another example of “condition” is that an image was shot in the extraordinary state; and in regards with a plurality of colors corresponding to a plurality of conditions, one example of “color” is a color that was extracted from an image that satisfies the condition that the image was shot in the ordinary state, another example of “color” is a color that was extracted from an image that satisfies the condition that the image was shot in the extraordinary state.

The representative color extracting unit 11 extracts, for each of the image groups obtained by the classification, a plurality of colors that respectively correspond to a plurality of conditions, as the representative colors.

Next, the representative color layout unit 12 lays out and displays the representative colors with distinction among the plurality of conditions at once, or lays out and displays the representative colors by switching among them.

The following describes examples of the plurality of conditions, and the separate or switched display of representative colors. It should be noted however that the present invention is not limited to the following examples.

(a) As the first example, the representative colors are displayed separately in a subject image region and a background image region for each image group.

Here, the subject image region is a region constituting a part of an image and containing a main subject such as a person. Also, the background image region is a region that remains after the subject image region is excluded from the image.

First, the image browsing device 1 extracts, from each image, a partial image that represents a subject which may be a person, a thing or the like, and sets the subject image region in the recording device in correspondence with a region constituted from the extracted partial image. The image browsing device 1 then sets, as the background image region, the region excluding the subject image region. Here, the image browsing device 1 may set the subject image with a manual operation, or automatically by a predetermined method.

Next, the representative color extracting unit 11 extracts, for each image group, the most main color of the subject image regions respectively set in the images included in the image group, and determines the extracted color as the representative color. The representative color extracted in this way is called a subject representative color. Further, the representative color extracting unit 11 extracts, for each image group, the most main color of the background image regions respectively set in the images included in the image group, and determines the extracted color as another representative color of the image group. The representative color extracted in this way is called a background representative color. In this way, the subject representative color and the background representative color are extracted from each image group.

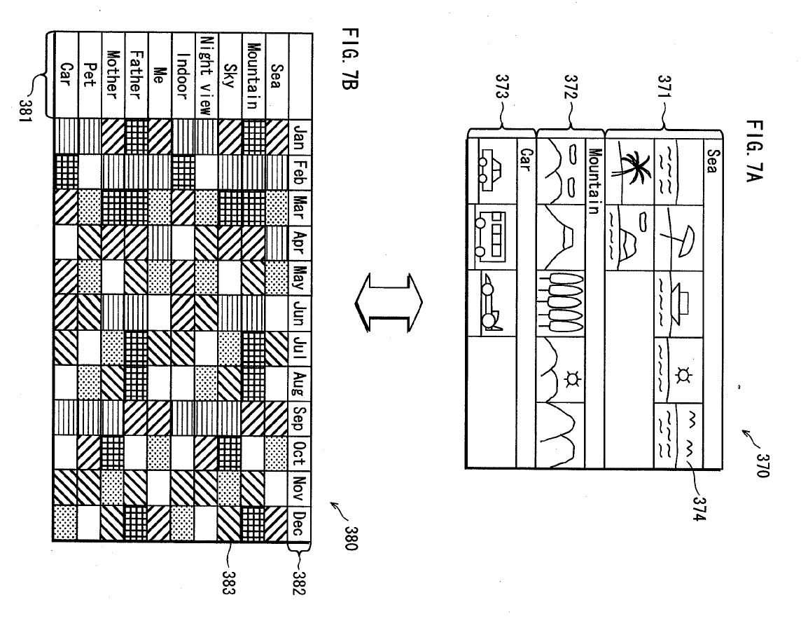

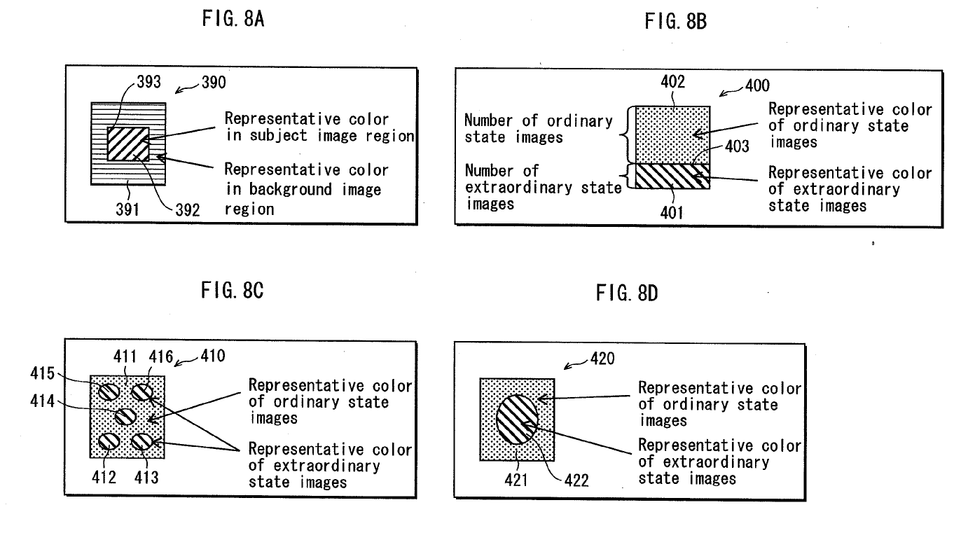

Next, as shown in FIG. 8A, the representative color layout unit 12 lays out and displays two representative colors of each image group, namely the subject representative color and the background representative color, separately by displaying the subject representative color in a subject representative color region 392 and the background representative color in a region surrounding the subject representative color region 392.

FIG. 8A shows display of representative colors of one image group. A plurality of representative colors, each of which is displayed in this way, can be displayed in alignment in correspondence with a plurality of image groups. This makes it possible to recognize, for each image group, a subject and its background that were photographed many times, by browsing the list.

In the example shown in FIG. 8A, two representative colors, namely the subject representative color and the background representative color are displayed with clear separation inside and outside the subject representative color region 392. However, not limited to this structure, the intermediate colors between the first and second representative colors may smoothly change by gradation.

(b) As the second example, a representative color extracted from images shot in the ordinary state and a representative color extracted from images shot in the extraordinary state are displayed separately in a display unit region.

In this case, the representative color extracting unit 11 extracts, for each image group, a representative color from the images set as the ordinary and a representative color from the images set as the extraordinary.

Next, the representative color layout unit 12 separately lays out and displays each set of two representative colors extracted from each image group, as shown in FIG. 8B.

As shown in FIG. 8B, the representative color layout unit 12 determines a ratio in area between regions 401 and 402 constituting a display unit region 400, to which the two contents of representative colors are to be applied, in accordance with a ratio of the number of images set as the ordinary and the number of images set as the extraordinary. Next, the representative color layout unit 12 sets the regions 401 and 402 in the display unit region 400 based on the determined ratio, and separately applies the representative colors to the set regions 401 and 402.

With this structure, when, for example, the images have been classified into image groups according to a predetermined time period, it is possible, as described earlier, to grasp at once a normal trend and a special trend for each time period, and also easily grasp the ratio between the images shot in the ordinary state and the images shot in the extraordinary state.

Also, when applying the representative colors separately for the images shot in the ordinary state and the images shot in the extraordinary state, the colors may be changed gradually from the first representative color to the second representative color by gradation.

In this case, the distribution of ordinary-state images and extraordinary-state images is indicated by whether the gradation is gentle or steep, namely, whether the change from the first representative color to the second representative color is gentle or steep. In other words, the distribution of ordinary-state images and extraordinary-state images is indicated by the level of the change in the color. That is to say, when the switch between the ordinary state and the extraordinary state appears frequently, the gradation is made gentle to indicate that the two conditions are mingled. On the other hand, in the case of less switches such as the case when the ordinary state continues for a long time, and then the extraordinary state continues for a long time, the gradation is made steep to indicate that the two conditions are separated.

Furthermore, as shown in FIGS. 8C and 8D, the pattern for separately applying representative colors may be changed to indicate the distribution of ordinary-state images and extraordinary-state images.

That is to say, when the switch between the ordinary state and the extraordinary state appears frequently, a layout is made such that a representative color of images shot in the extraordinary state is dispersed in a representative color of images shot in the ordinary state to indicate that the two conditions are mingled, as shown in FIG. 8C. That is to say, five circular regions 412, . . . , 416 are laid out in a display unit region 410, and a representative color of images shot in the extraordinary state is applied to each of the circular regions 412, . . . , 416. A representative color of images shot in the ordinary state is applied to the background region. Note that the regions 412, . . . , 416 are called extraordinary regions.

On the other hand, in the case of less switches such as the case when the ordinary state continues for a long time, and then the extraordinary state continues for a long time, a layout is made such that a representative color of images shot in the extraordinary state is applied to a large region surrounded by a representative color of images shot in the ordinary state to indicate that the two conditions are separated from each other, as shown in FIG. 8D. That is to say, one circular region 422 is laid out in a display unit region 440, and a representative color of images shot in the extraordinary state is applied to the circular region 422. A representative color of images shot in the ordinary state is applied to the background region.

The frequency of the switch between the ordinary state and the extraordinary state is determined as follows.

For example, a time period of one month is presumed for this purpose. And for example, the frequency is determined to be high when the ordinary state and the extraordinary state switch once every day in this period; and the frequency is determined to be low when the ordinary state and the extraordinary state switch once every 10 days.

The level of frequency of the switch between the ordinary state and the extraordinary state can be determined, for example, based on the ratio between, in a predetermined time period (represented as “m” days), the number of days (represented as “n” days) for which the ordinary state occurs continuously and the number of days (represented as “n” days) for which the extraordinary state occurs continuously.

Here, the level of frequency of the switch (“L”) may be represented by five levels such that L=1 when m≦2n; L=2 when 2n<m≦5n; L=3 when 5n<m≦10n; L=4 when 10n<m≦15n; and L=5 when m>15n.

Also, the level of frequency of the switch may be determined based on the number of switches that occur in a predetermined period, where each of the ordinary state and the extraordinary state continues for a predetermined number of days in the period.

Here, the level of frequency of the switch (“L”) may be represented by five levels such that L=1 when one or less switch occurs in the period; L=2 when four or less switches occur in the period; L=3 when nine or less switches occur in the period; L=4 when 14 or less switches occur in the period; and L=5 when 15 or more switches occur in the period.

Note that the patterns of applying colors separately are not limited to those described above, but may be any other patterns such as those in which the extraordinary region is varied in shape, position, size, or direction, as far as the patterns can clearly indicate the distribution of images satisfying a plurality of conditions.

For example, the shape of the extraordinary region may be a circle, ellipse, rectangle, polygon, or star. Also, a plurality of extraordinary regions may be laid out as a matrix in the display unit region, laid out in concentration at the center of the display unit region, or laid out in concentration at a part of the display unit region. Also, for example, the size of the extraordinary region may be, in area, any of 1%, 2%, 3%, 4%, and 5% of the display unit region. Also, any combination of these examples may be used.

(c) Lastly, as the third example, a representative color may be extracted for each tag attached to the image, and a plurality of representative colors extracted in this way may be displayed with switching among them.

In this case, the representative color extracting unit 11 extracts a representative color for each of tags associated with the images included in each image group, where the target thereof is only the images that are associated with the tags, and the representative colors are the main colors of respective images.

More specifically, when each of the images included in an image group is associated with a tag, the representative color extracting unit 11 extracts, as the representative color, the main color of the images associated with tag “mountain” among the images included in the image group, the main color of the images associated with tag “sea” among the images included in the image group, and the main color of the images associated with tag “sky” among the images included in the image group.

As described above, the representative color extracting unit 11 extracts, as the representative color, the main color of images associated with a tag in each image group, with respect to each content of tag. In this way, a representative color is extracted for each content of tag.

Next, the representative color layout unit 12 displays the representative colors extracted for each content of tag in order by switching among them.

In so doing, it is possible to represent the distribution of the tags respectively associated with the images, by the pattern of switching among the representative colors.

That is to say, as the number of types of tags associated with images included in the target image group increases, switching among the tags occurs at a shorter time interval; and as the number of types of tags associated with the images decreases, switching among the tags occurs at a longer time interval.

With this structure, it is possible to recognize easily whether there are a large or small number of types of tags, namely, whether various subjects are included in the shot images.

(d) Other than the above-described conditions for the representative colors to be displayed separately or with switching, there are conditions such as whether the image was shot inside or outside a building, whether the image was shot in a region while the user was staying in the region, and whether the image was shot while the user was moving from one region to another region. Note that the conditions are not limited to these.

### (8) Use of Color System

Next, a description is given of the case where the image browsing device 1 of the present invention generates color components by assigning a plurality of pieces of information included in a plurality of images, or a plurality of pieces of information indicated by tags attached to images, to different color components of a predetermined color system, generates combined representative colors based on the generated color components, and displays the generated combined representative colors.

In this case, the representative color extracting unit 11 generates a plurality of representative colors corresponding to a plurality of pieces of information, for each of the classified image groups. Here, when generating the representative colors for each piece of information, the representative color extracting unit 11 uses predetermined color components of a predetermined color system. Following this, the representative color extracting unit 11 generates final representative colors by combining representative colors generated for each piece of information.

The following describes the operation of the representative color extracting unit 11 in a specific example. Note however that the present invention is not limited to the example described here.

(a) As the first example, the representative color extracting unit 11 uses the HLS color space. The HLS color space is a color space composed of three components: Hue (H); Luminance (L); and Saturation (S).

The representative color extracting unit 11 represents the main colors of images by the hue and saturation, and represents the level of ordinary/extraordinary by the luminance. That is to say, the representative color extracting unit 11 extracts main colors from the images included in an image group, and extracts the hues and saturations from the extracted main colors.

Next, the representative color extracting unit 11 calculates the luminance based on the ratio, in number, of the images that were set by the ordinary/extraordinary setting unit 14 as having been shot in the extraordinary state to all the images included in the image group. The higher the ratio is, the higher the luminance is; and the smaller the ratio is, the lower the luminance is. For example, when the aforesaid ratio of the extraordinary is 0%, 1%, 2%, . . . , 100%, the luminance is calculated as 0%, 1%, 2%, . . . , 100%, respectively.

Next, the representative color extracting unit 11 obtains final representative colors by combining the hues and saturations calculated from the main colors, with the luminance calculated from the ratio.

With such an operation, it is possible to grasp the contents of the image group by the main colors of the images, as well as easily grasping the ratio between the ordinary and extraordinary states.

(b) As the second example, the representative color extracting unit 11 represents the main colors of a plurality of images included in an image group by the hues, represents the level of match among the main colors of the plurality of images included in the image group by the saturations, and represents the number of images included in the image group by the luminance.

That is to say, the representative color extracting unit 11 extracts one main color from a plurality of images included in an image group, and extracts the hue from the extracted main color.

Next, the representative color extracting unit 11 extracts main colors respectively from the plurality of images included in the image group. The representative color extracting unit 11 then counts the number of images corresponding to a color, for each color, and calculates a ratio of the largest number of images, among the calculated numbers, to the number of all images included in the image group. The representative color extracting unit 11 then calculates the saturation using the calculated ratio. For example, when the calculated ratio is 0%, 1%, 2%, . . . , 100%, the saturation is calculated as 0%, 1%, 2%, . . . , 100%, respectively. In this way, the levels of match of colors in each color included in the image group are assigned to the saturations, and the saturation is made lower when more colors other than the main color are included in the image, and the saturation is made higher when the main color occupies more part of the image.

Further, the representative color extracting unit 11 assigns the number of images included in the image group to the luminance, and increases the luminance as the number of images increases. For example, the calculates a ratio of the number of images included in the image group to the number of all images stored in the recording device, and when the calculated ratio is 0%, 1%, 2%, . . . , 100%, the luminance is calculated as 0%, 1%, 2%, . . . , 100%, respectively.

Lastly, the representative color extracting unit 11 obtains final representative colors by combining the obtained hue, saturation, and luminance.

With this structure, it is possible to grasp at once the contents of the image group by the main colors of the images, as well as easily grasping whether contents other than the contents represented by the main colors are included in the image group, and how many images are included in the image group.

In the above-described two example, a color system composed of the hue, luminance, and saturation is used. However, not limited to this, other color systems may be used. It should be noted however that the color system composed of the hue, luminance, and saturation is preferable in the sense that a plurality of piece of information are associated with the brightness, vividness and the like of the color.

(c) There are many color systems such as: a color system composed of R, G, and B corresponding to the three primary colors (RGB color model); a color system using the brightness and color difference; a color system using the HLS color space; and a color system using the HSV (Hue, Saturation, Value) color space (HSV model). The representative color extracting unit 11 may use any of these color systems.

(Using RGB Color Model)

The RGB color model is one of the methods for representing colors. The RGB color model provides reproduction of broad colors by combining the three primary colors: red, green, and blue.

When the RGB color model is used, the representative color extracting unit 11, for example, extracts a main color from images included in an image group, extracts red and green from the extracted main color, and determines blue based on the ratio, in number, of the images that were set by the ordinary/extraordinary setting unit 14 as having been shot in the extraordinary state to all the images included in the image group. The representative color extracting unit 11 obtains final representative colors using the extracted and determined red, green and blue.

Here, when red and green of the RGB color model are to be extracted from JPEG-format images included in the image group, conversion equations for conversion from brightness and color difference to RGB, which will be explained later, may be used.

(Using Brightness and Color Difference)

The system with the brightness and color difference represents the colors by a component “Y” representing the brightness, two color signals (blue and red), and components “Cb” and “Cr” (color difference) representing a difference between brightness signals.

When the system with the brightness and color difference is used, the representative color extracting unit 11, for example, extracts a main color from images included in an image group, extracts two color difference components “Cb” and “Cr” from the extracted main color, and determines the brightness component “Y” based on the ratio of the number of images that were set by the ordinary/extraordinary setting unit 14 as having been shot in the extraordinary state, to the total number of images included in the image group. The representative color extracting unit obtains final representative colors using the obtained brightness component “Y” and two color difference components “Cb” and “Cr”.

(Using HSV Color Space)

The HSV color space is a color space composed of three components: Hue (H); Value (V); and Saturation (S).

When using the HSV color space, the representative color extracting unit 11 operates in the same manner as when it operates using the HLS color space.

### (9) Conversion Between Y, Cr, and Cb in Used in JPEG and R, G, and B Used in Computers

The following shows one example of conversion from RGB to brightness and color difference.

Y=0.29891×R+0.58661×G+0.11448×B

Cb=−0.16874×R−0.33126×G+0.50000×B

Cr=0.50000×R−0.41869×G−0.08131×B

Also, the following shows one example of conversion from brightness and color difference to RGB.

R=Y+1.40200×Cr

G=Y−0.34414×Cb−0.71414×Cr

B=Y+1.77200×Cb

### 2. EMBODIMENT 2

The following describes an image browsing device 2 in the second embodiment of the present invention.

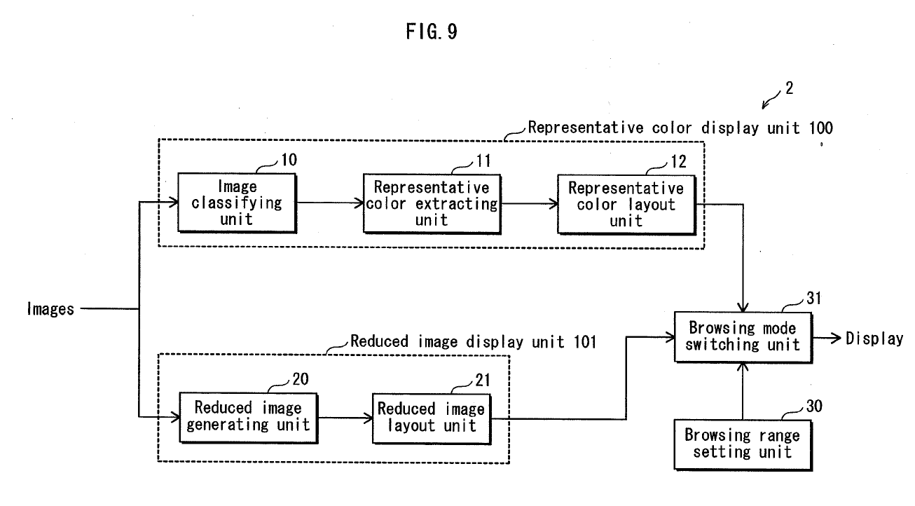

The image browsing device 2, as shown in FIG. 9, is composed of a representative color display unit 100, a reduced image display unit 101, a browsing range setting unit 30, and a browsing mode switching unit 31. Also, the representative color display unit 100 is composed of an image classifying unit 10, a representative color extracting unit 11, and a representative color layout unit 12. The reduced image display unit 101 is composed of a reduced image generating unit 20 and a reduced image layout unit 21.

The image browsing device 2 is specifically a computer system that includes a microprocessor, ROM, RAM, a hard disk unit, a liquid crystal display unit, a keyboard and the like. A computer program is stored in the RAM or the hard disk unit. The microprocessor operates in accordance with the computer program and the image browsing device 2 achieves its functions.

Among the constituent elements of the image browsing device 2 shown in FIG. 9, the constituent elements having the same reference signs as those of the image browsing device 1 shown in FIG. 1 have the same functions as those of the image browsing device 1 shown in FIG. 1.

The representative color display unit 100 operates in the same manner as in Embodiment 1. After a plurality of image files are read out from a recording device, first, the image classifying unit 10 classifies the read-out plurality of image files into one or more image groups based on a predetermined criterion.

Next, the representative color extracting unit 11 extracts a representative color for each of the image groups obtained by the image classifying unit 10, the representative color indicating a characteristic of the image group. The representative color layout unit 12 lays out the extracted representative colors.

The reduced image display unit 101 processes the thumbnail display of images. More specifically, after a plurality of image files are read out from a recording device and input, the reduced image generating unit 20 generates thumbnail images by reducing the input images to a predetermined size.

Next, the reduced image layout unit 21 lays out the generated thumbnail images.

The browsing range setting unit 30 sets a range of images to be browsed among a plurality of images. For example, the browsing range setting unit 30 receives specification of a range of shooting dates/times from the user, and sets the specified range of shooting dates/times. Alternatively, the browsing range setting unit 30 receives specification of a retrieval condition from the user, and sets the specified retrieval condition.

For example, when the range of shooting dates/times is set, the target of browsing is images that were shot within the set range of shooting dates/times, among a plurality of images stored in the recording device. Also, when the retrieval condition is set, the target of browsing is images that satisfy the set retrieval condition, among the plurality of images stored in the recording device.

Next, the browsing mode switching unit 31 switches between the browsing modes in which displays are performed for browsing, in accordance with the browsing range set by the browsing range setting unit 30. More specifically, the browsing mode switching unit 31 switches between: a display by the representative color display unit 100 (representative color browsing mode); and a display by the reduced image display unit 101 (thumbnail browsing mode).

Here, the browsing mode switching unit 31 may switch between the browsing modes in accordance with the following criterions.

(a) The number of images included in the browsing range is used as the criterion, and when the number of images does not exceed a predetermined number, the display is performed in the thumbnail browsing mode, and when the number of images exceeds the predetermined number, the display is performed in the representative color browsing mode.

(b) The shooting dates/times included in the browsing range are used as the criterion, and when shooting dates/times of all images included in the browsing range are within a time period of a predetermined length, the display is performed in the thumbnail browsing mode, and when the range of the shooting dates/times of all images included in the browsing range exceeds the time period of the predetermined length, the display is performed in the representative color browsing mode.

Note that the specific criterions for switch between the browsing modes are not limited to the above-described two criterions.

With the above-described structure where: the display is performed in the thumbnail browsing mode when the amount of images in the browsing range is within a predetermined range; and the display is performed in the representative color browsing mode when the amount of images in the browsing range exceeds the predetermined range, it is possible to browse the images in an appropriate display mode, which is determined depending on the amount of images of the browsing target.

FIGS. 6 and 7 show examples of switching between screen displays in the thumbnail browsing mode and the representative color browsing mode.

FIGS. 6A through 6B show examples of the case where images are laid out in bulks on a time axis, for each predetermined shooting period. FIG. 6A shows an example of the screen display in the thumbnail browsing mode, and FIG. 6B shows an example of the screen display in the representative color browsing mode. In the example shown in FIG. 6A, photographs taken during three months from July to September are displayed for each month as thumbnails. For FIG. 6B, refer to description in Embodiment 1.

In the example shown in FIG. 6A, thumbnail images of only three months can be displayed on one screen. In view of this, when the browsing range is a period of three months or shorter, the display is performed in the thumbnail browsing mode as shown in FIG. 6A, and when the browsing range is a period exceeding three months, the display is performed in the representative color browsing mode as shown in FIG. 6B.

FIGS. 7A through 7B show examples of screen displays where images are laid out based on the tags whose contents are associated with the images. As is the case with FIG. 6, FIG. 7A shows an example of the screen display in the thumbnail browsing mode, and FIG. 7B shows an example of the screen display in the representative color browsing mode.

In the example shown in FIG. 7A, thumbnail images are displayed for each of three types of tags associated with the images. For FIG. 7B, refer to description in Embodiment 1.

In the example shown in FIG. 7A, only 20 thumbnail images can be displayed at a maximum on one screen. In view of this, when the number of images in the browsing range is 20 or less, the display is performed in the thumbnail browsing mode as shown in FIG. 7A, and when the number of images in the browsing range exceeds 20, the display is performed in the representative color browsing mode as shown in FIG. 7B.

### 3. EMBODIMENT 3

The following describes an image browsing system 6 in the third embodiment of the present invention.

### 3.1 Image Browsing System 6

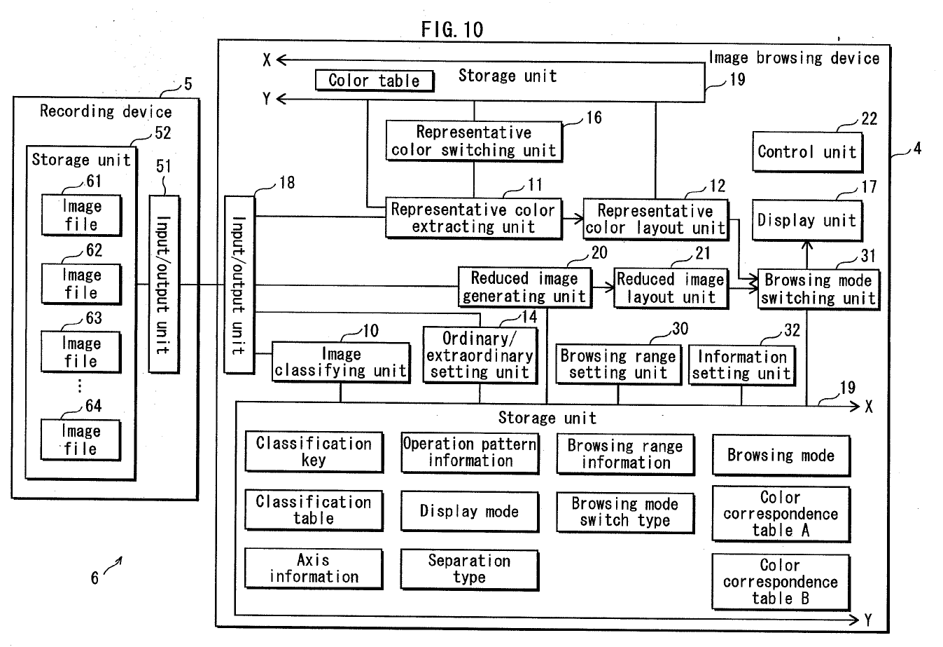

The image browsing system 6, as shown in FIG. 10, is composed of an image browsing device 4 and a recording device 5.

The recording device 5 is attached to the image browsing device 4 by the user in the state where it has been recorded with a plurality image files. The image browsing device 4, in accordance with a user operation, reads out the image files from the recording device 5, either generates thumbnail images or determines representative colors based on the read-out image files, and displays a list of either thumbnail images or representative colors.

### 3.2 Recording Device 5

The recording device 5 is, for example, an SD memory card and includes an input/output unit 51 and a storage unit 52, as shown in FIG. 10.

The storage unit 52 preliminarily store a plurality of files 61, 62, 63, . . . , 64 that were created from images taken by a digital camera or the like.

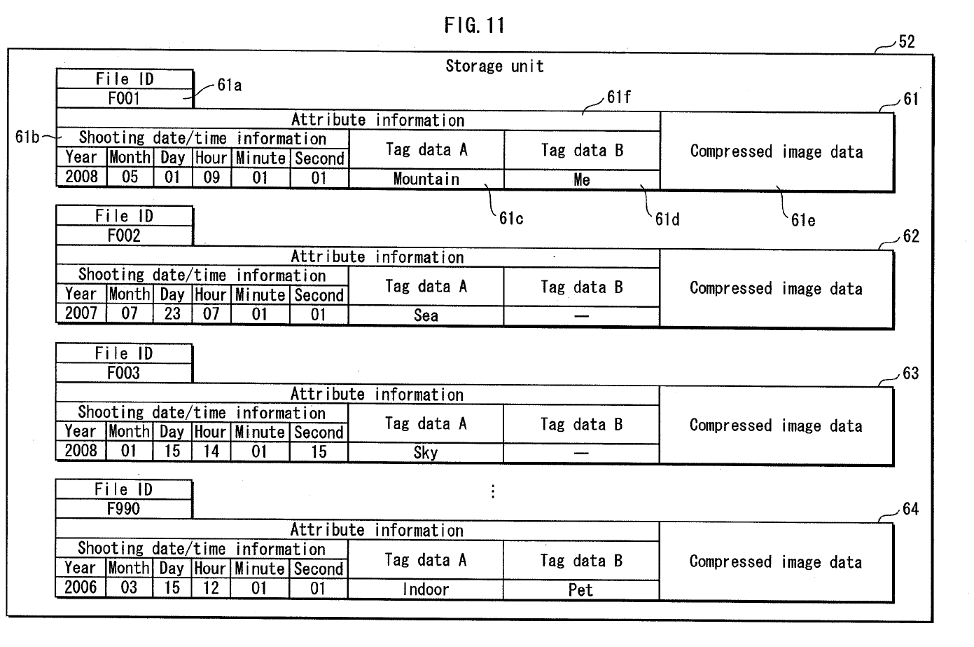

As shown in FIG. 11, each image file is attached with a file ID for identifying the image file uniquely. Each image file includes attribute information and compressed image data. The attribute information includes shooting date/time information, tag data A, and tag data B. In the case where an ordinary/extraordinary distinction is set by the image browsing device 4 as will be described later, the attribute information includes the ordinary/extraordinary distinction.

The shooting date/time information indicates the time when the compressed image data included in the image file was generated by a shooting, and is composed of year, month, day, hour, minute, and second.

The tag data A is attached to each image file by the user for classification of the image files, and includes information indicating the location, time band, environment, circumference or the like in regards with the shooting of the image. For example, the tag data A indicates any of “sea”, “mountain”, “sky”, “night view”, and “indoor”, as described earlier. When the tag data A indicates any of “sea”, “mountain”, “sky”, “night view”, and “indoor”, it means that the image of the image file was shot with the sea, mountain, sky, night view, or indoor. Also, tag data B is attached to each image file by the user for classification of the image files, and includes information indicating the main subject of the shooting. For example, the tag data B indicates any of “me”, “father”, “mother”, “pet”, and “car”, as described earlier. When the tag data B indicates any of “me”, “father”, “mother”, “pet”, and “car”, it means that the image formed by the image file includes, as the main subject, “me”, father, mother, pet, or car.

The ordinary/extraordinary distinction indicates whether the image file was shot in the ordinary state or in the extraordinary state.

The compressed image data is generated by compressing and encoding image data, which is composed of a plurality of pieces of pixel data, with high degree of efficiency. Each piece of image data is, for example, composed of one piece of brightness data and two pieces of color difference data.

For example, as shown in FIG. 11, an image file 61 is attached with a file ID 61a “Fool”, the image file 61 includes attribute information 61f and compressed image data 61e, and the attribute information 61f includes shooting date/time information 61b “20080501090101”, tag data A 61c “mountain”, and tag data B 61d “me”.

The input/output unit 51 receives information from an external device to which the recording device 5 has been attached, and writes the received information into the storage unit 52. Also, the input/output unit 51 reads out information from the storage unit 52, and outputs the read-out information to the external device to which the recording device 5 has been attached.

### 3.3 Image Browsing Device 4

The image browsing device 4, as shown in FIG. 10, includes an image classifying unit 10, a representative color extracting unit 11, a representative color layout unit 12, an ordinary/extraordinary setting unit 14, a representative color switching unit 16, a display unit 17, an input/output unit 18, a storage unit 19, a reduced image generating unit 20, a reduced image layout unit 21, a browsing range setting unit 30, a browsing mode switching unit 31, and an information setting unit 32.

The image browsing device 4 is specifically a computer system that includes a microprocessor, ROM, RAM, a hard disk unit, a liquid crystal display unit, a keyboard and the like. A computer program is stored in the RAM or the hard disk unit. The microprocessor operates in accordance with the computer program and the image browsing device 4 achieves its functions.

(1) List Screens Displayed by Image Browsing Device 4

The following describes several types of list screens displayed by the image browsing device 4.

(Representative Color List Screen 320)

A representative color list screen 320, as shown in FIG. 3, shows representative colors of, for example, 10 years for each month and year.

In the representative color list screen 320, a plurality of years (in this particular example, from 1997 to 2006) are arranged in time sequence on the vertical axis 321, and 12 months (from January to December) are arranged in time sequence on the horizontal axis 322. In this example, 10 (in the direction of the vertical axis 321) by 12 (in the direction of the horizontal axis 322) rectangular display unit regions are laid out as a matrix. Namely, 120 display unit regions are laid out in total. A display unit region at an intersection of a year on the vertical axis 321 and a month on the horizontal axis 322 displays a representative color of the month in the year.

(Representative Color List Screen 330)

A representative color list screen 330, as shown in FIG. 4, shows representative colors of, for example, one month for each day.

In the representative color list screen 330, seven rectangular display frames are laid out in each row in the direction of a horizontal axis 335, and six rectangular display frames are laid out in each column in the direction of a vertical axis, as a matrix. Namely, 42 display frames are laid out in total. The seven days of the week (specifically, “Sun”, “Mon”, “Tue”, “Wed”, “Thu”, “Fri”, and “Sat”) are displayed in the stated order in the seven display frames laid out immediately above the horizontal axis 335, and in each of the remaining 35 display frames, a date and a display unit region are displayed in the order of the seven days of the week and in the order along the vertical axis. In each display unit region, a representative color of the corresponding date is displayed.

(Representative Color List Screen 380)

A representative color list screen 380, as shown in FIG. 7B, shows representative colors of, for example, one year for each content of tag and each month.

In the representative color list screen 380, a vertical axis 381 represents a plurality of contents of tags, and a horizontal axis 382 represents 12 months in time sequence. In this example, 10 (in the vertical axis direction) by 12 (in the horizontal axis direction) rectangular display unit regions are laid out as a matrix. Namely, 120 display unit regions are laid out in total. A display unit region at an intersection of a tag content on the vertical axis 381 and a month on the horizontal axis 382 displays a representative color of the tag content and the month.

(Thumbnail List Screen 350)

A thumbnail list screen 350, as shown in FIG. 6A, shows thumbnails of, for example, three months for each month.

The thumbnail list screen 350 is composed of display frames 351, 352, and 353 respectively for the three months, and each display frame is composed of a month display field for displaying the month and a thumbnail display field for displaying the thumbnails. The thumbnail display field displays a plurality of thumbnails.

(Thumbnail List Screen 370)

A thumbnail list screen 370, as shown in FIG. 7A, shows thumbnails, for example, for each tag content.

The thumbnail list screen 370 is composed of display frames 371, 372, and 373 respectively for three tag contents, and each display frame is composed of a tag content display field for displaying the tag content and a thumbnail display field for displaying the thumbnails. The thumbnail display field displays a plurality of thumbnails.

(2) Method for Applying Colors Separately for Display Unit Regions Constituting Each List Screen

The image browsing device 4 can apply a plurality of colors to the display unit regions constituting each list screen. Here, a description is given of how the image browsing device 4 applies colors to the display unit regions constituting each list screen.

Representative colors are applied to the subject image region and the background image region separately as follows. As shown in FIG. 8A, a display unit region 390 is segmented by a border line 393 into a rectangular internal region 392 and an external region 391. The representative color of the background image region is applied to the external region 391, and the representative color of the subject image region is applied to the internal region 392.

Also, the representative colors are applied separately for images shot in the ordinary state and images shot in the extraordinary state, as follows. As shown in FIG. 8B, a display unit region 400 is segmented by a border line 403 into two regions 401 and 402. The representative color of images shot in the ordinary state is applied to the region 402, and the representative color of images shot in the extraordinary state is applied to the region 401.

Further, each display region may be segmented into a plurality of small regions such that the number of small regions varies depending on the frequency with which a switch between the ordinary state and the extraordinary state occurs in a predetermined time period. For example, when the switch between the ordinary state and the extraordinary state occurs frequently, as shown in FIG. 8C, a large number of extraordinary regions 412, . . . , 416 may be laid out, and the representative colors may be applied to represent that the two conditions are mingled; and when the switch between the ordinary state and the extraordinary state occurs less frequently, as shown in FIG. 8D, a small number of extraordinary regions, namely, an extraordinary region 422 in this example may be laid out, and the representative colors may be applied to represent that the two conditions are separated from each other.

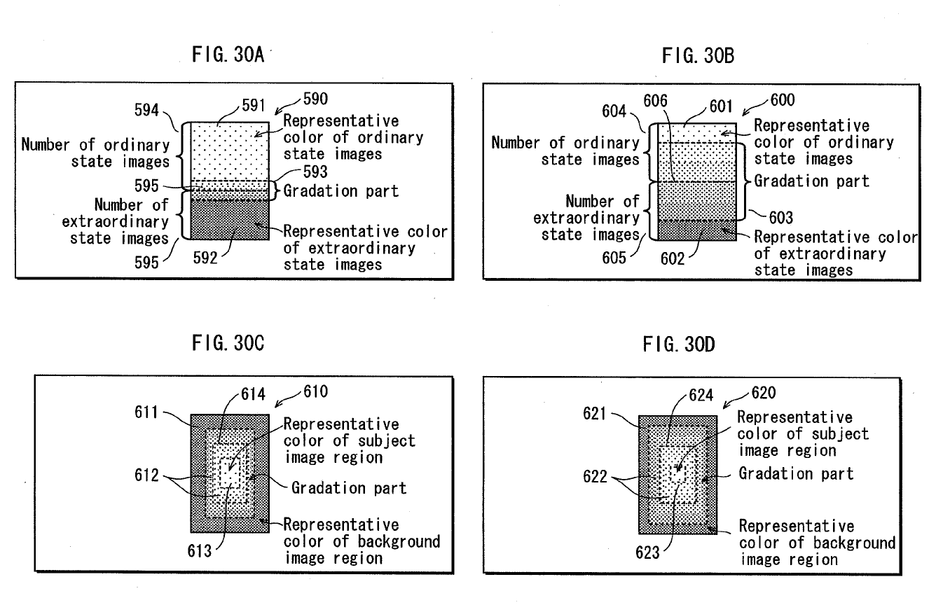

Still further, when the representative colors are applied to the subject image region and the background image region separately, the following structure may be constructed. As shown in FIG. 30C, a display unit region 610 is segmented by a border line 614 into a rectangular internal region and an external region. Then a border region 612 is formed to have a predetermined width on either side of the border line 614. Representative colors of the background image region and the subject image region are applied to representative color regions 611 and 613 that exist respectively outside and inside the border region 612 within the display unit region 610. Intermediate colors are then applied to the border region 612 so that the colors smoothly change gradually from the first representative color applied to the first representative color region 611 to the second representative color applied to the second representative color region 613.

Still further, when the representative colors of images shot in the ordinary state and images shot in the extraordinary state are applied separately, the following structure may be constructed. As shown in FIG. 30A, a display unit region 590 is segmented by a border line 595 into upper and lower regions. Then a border region 593 is formed to have a predetermined width on either side of the border line 595. Representative colors of images shot in the ordinary state and images shot are applied to representative color regions 591 and 592 that exist respectively on the upper and lower sides of the border region 593 within a display unit region 590. Intermediate colors are then applied to the border region 593 so that the colors smoothly change gradually from the first representative color applied to the first representative color region 591 to the second representative color applied to the second representative color region 592.

(3) Application of Methods for Applying Colors Separately Shown in FIGS. 8A Through 8D

Here, a description is given of applications of the methods for applying colors separately shown in FIGS. 8A through 8D, with reference to several types of list screens displayed by the image browsing device 4.

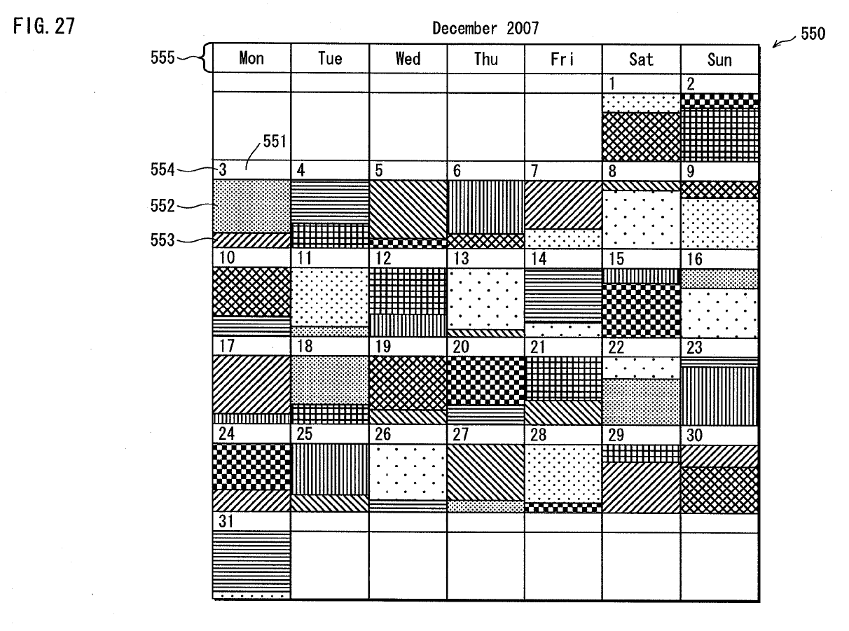

A representative color list screen 550 shown in FIG. 27 is a list screen that is displayed when the method shown in FIG. 8B is applied to the representative color list screen 330 shown in FIG. 4.

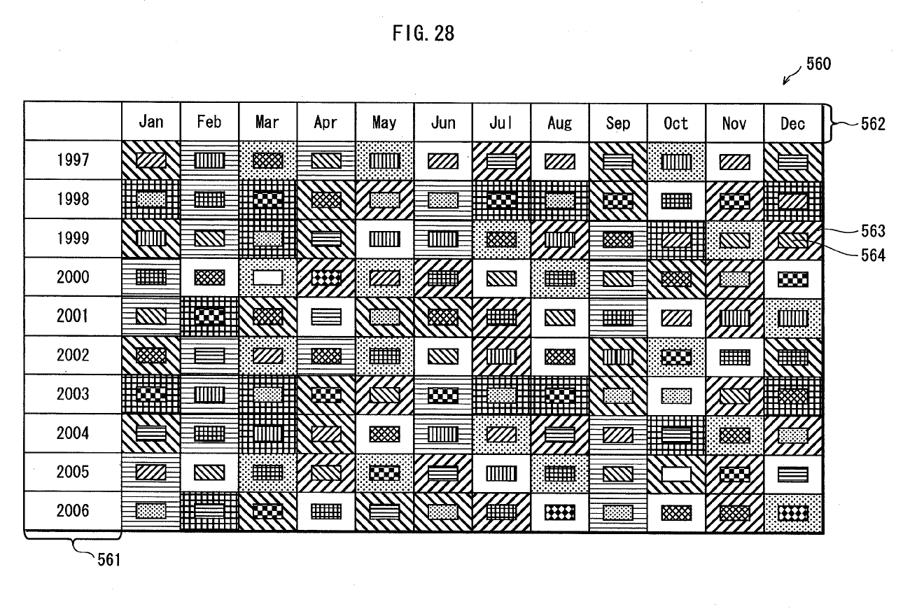

Also, a representative color list screen 560 shown in FIG. 28 is a list screen that is displayed when the method shown in FIG. 8A is applied to the representative color list screen 320 shown in FIG. 3.

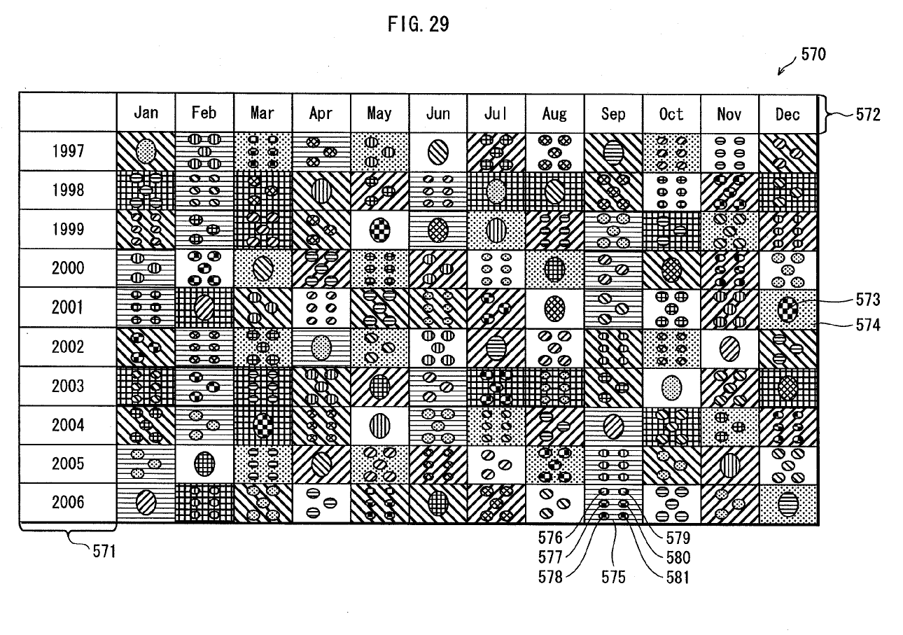

Further, a representative color list screen 570 shown in FIG. 29 is a list screen that is displayed when the methods shown in FIGS. 8C through 8D are applied to the representative color list screen 320 shown in FIG. 3.

(4) Storage Unit 19

The storage unit 19, as shown in FIG. 10, has storage regions for storing a classification key, a classification table, axis information, operation pattern information, a display mode, a separation type, browsing range information, a browsing mode switch type, a browsing mode, a color table, a color correspondence table A, a color correspondence table B, and a presence/absence of switch between ordinary and extraordinary.

(Classification Key)

The classification key is used for classifying a plurality of image files stored in the storage unit 52 of the recording device 5. The classification key is composed of part or all of the attribute information included in each image file.

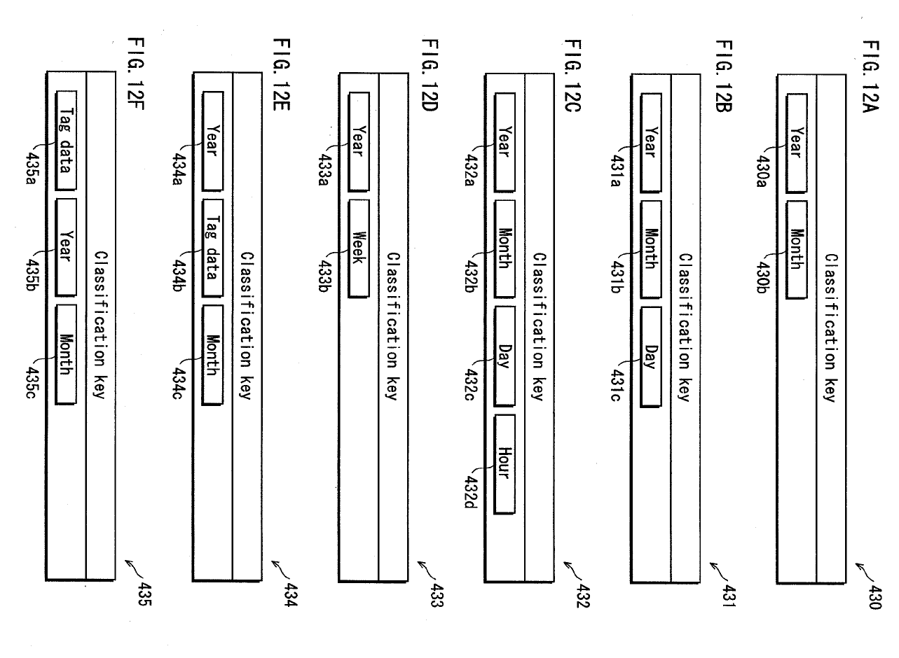

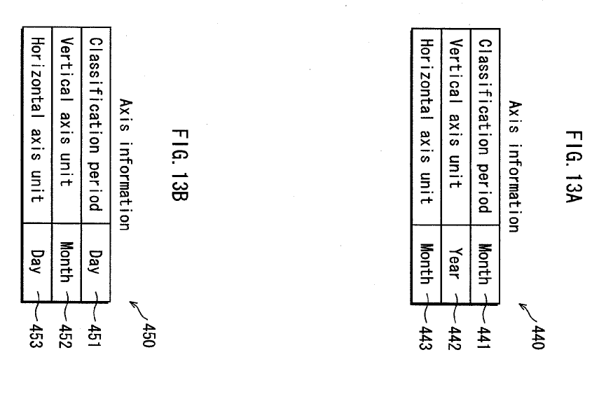

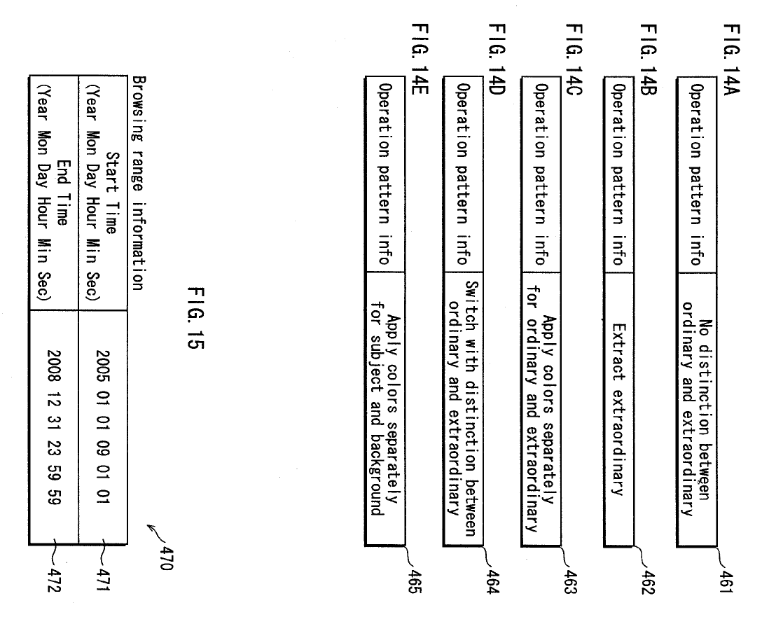

FIGS. 12A through 12F show six types of classification keys. As shown in FIG. 12: a classification key 430 is composed of a year 430a and a month 430b; a classification key 431 is composed of a year 431a, a month 431b, and a day 431c; a classification key 432 is composed of a year 432a, a month 432b, a day 432c, and an hour 432d; a classification key 433 is composed of a year 433a and a week 433b; a classification key 434 is composed of a year 434a, tag data 434b, and a month 434c; and a classification key 435 is composed of tag data 435a, a year 435b, and a month 435c.

Here, the year, month, and day indicate respectively the year, month, and day contained in the attribute information included in each image file. Also, the week indicates a week in which the year, month, and day of the attribute information of each image file are included. Further, the tag data indicates the tag data A or B contained in the attribute information included in each image file.

For example, the classification key 431 indicates that classification-target image files among a plurality of image files stored in the storage unit 52 of the recording device 5 should be relaid out in the ascending order of the years, months, and days indicated by the attribute information included in each image file. Also, for example, the classification key 435 indicates that classification-target image files among a plurality of image files stored in the storage unit 52 of the recording device 5 should be relaid out in the ascending order of the tag data, years, and months.

One of the classification keys is specified by the user.

Note that the classification keys are not limited to the above-described ones, but other combinations are possible.

Note also that the storage unit 19 does not store all of the six types of classification keys, but stores only one classification key temporarily, and the only the stored one classification key is used. However, not limited to this, the storage unit 19 may store all classification keys including the six types of classification keys, and one of the stored classification keys may be used temporarily.

(Axis Information)

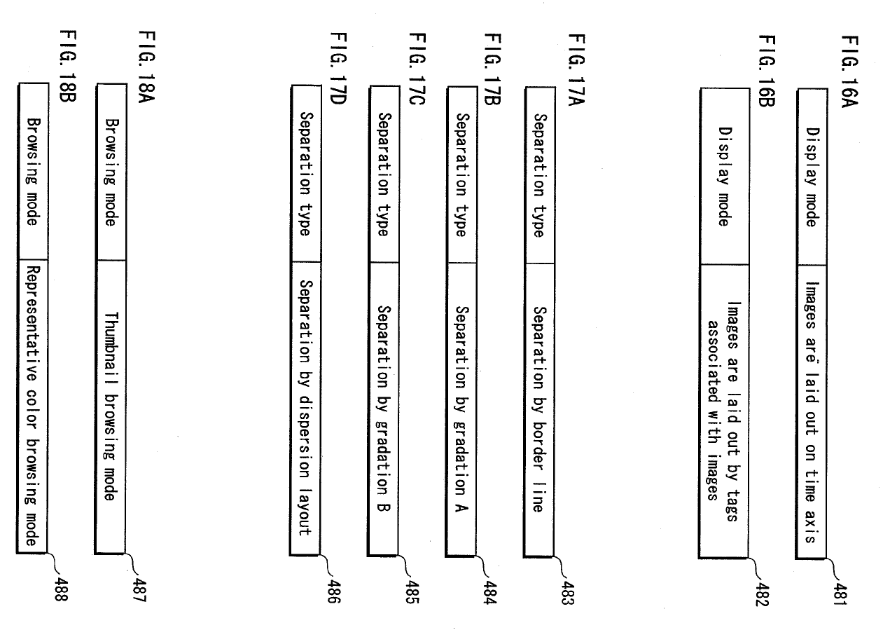

The axis information, when a representative color list is to be displayed, is used to determine the minimum unit for classifying a plurality of image files stored in the storage unit 52 of the recording device 5, and to determine the unit for displaying the vertical and horizontal axes of the list. As shown in FIGS. 13A and 13B as examples, the axis information is composed of a classification period, a vertical axis unit, and a horizontal axis unit.

The classification period indicates the minimum unit for classifying the plurality of image files stored in the storage unit 52 of the recording device 5. That is to say, when a plurality of image files are to be classified into groups, which are each a group of image files having a same characteristic in common, the classification period indicates the same characteristic. For example, in FIG. 13A, axis information 440 includes classification period 441 “month”. In this case, the same characteristic means that the attribute information contains the same year and month. When the classification period 441 is used, image files are classified into groups, which are each a group of image files having in common the attribute information that contains the same year and month. Also, as another example, in FIG. 13B, axis information 450 includes classification period 451 “day”. In this case, the same characteristic means that the attribute information contains the same year, month, and day. When the classification period 451 is used, image files are classified into groups, which are each a group of image files having in common the attribute information that contains the same year, month, and day.

The vertical axis unit and the horizontal axis unit contained in the axis information, when a representative color list to be displayed as a matrix with the vertical axis and horizontal axis, indicate the units in which the vertical axis and horizontal axis are displayed, respectively. For example, in FIG. 3 showing the representative colors as a matrix, the vertical axis is displayed in units of years, and the horizontal axis is displayed in units of months. Also, in FIG. 4 showing the representative colors as a matrix, the vertical axis is displayed in units of days, and the horizontal axis is displayed in units of days of the week. Further, in FIG. 7B showing the representative colors as a matrix, the vertical axis is displayed in units of tag contents, and the horizontal axis is displayed in units of months.

As one example, the axis information 440 shown in FIG. 13A includes vertical axis unit 442 “year” and horizontal axis unit 443 “month”. This means that the representative colors should be displayed as a matrix, with the vertical axis being displayed in units of years, and the horizontal axis being displayed in units of months, as shown in FIG. 3. As another example, the axis information 450 shown in FIG. 13B includes vertical axis unit 452 “month” and horizontal axis unit 453 “day”. This means that the representative colors should be displayed as a matrix, with the vertical axis being displayed in units of months, and the horizontal axis being displayed in units of days.

Note that the axis information is not limited to those shown in FIGS. 13A and 13B, but other combinations are possible.

Note also that the storage unit 19 does not store all of the two pieces of axis information shown in FIGS. 13A and 13B, but stores only one piece of axis information temporarily, and only the stored piece of axis information is used. However, not limited to this, the storage unit 19 may store all information including the two pieces of axis information, and one of the two pieces of axis information may be used temporarily.

(Operation Pattern Information)

The operation pattern information indicates an operation pattern for extracting and displaying representative colors. More specifically, as shown in FIG. 14A through 14E, operation pattern information 461, . . . , 465 respectively indicate “no distinction between ordinary and extraordinary”, “extract extraordinary”, “apply colors separately for ordinary and extraordinary”, “switch with distinction between ordinary and extraordinary”, and “apply colors separately for subject and background”.

(Browsing Range Information)

The browsing range information, in the image browsing device 4, defines a time range for image files which are targets of the process of extracting representative colors or reducing the images. The browsing range information is composed of a start time and an end time.

More specifically, image files that include attribute information containing the shooting date/time information that falls within the range from the start time to the end time are the targets of the process of extracting representative colors or reducing the images. Here, each of the start time and the end time is composed of year, month, day, hour, minute, and second.

Browsing range information 470 shown in FIG. 15 is composed of start time 471 “20050101090101” and an end time 472 “20081231235959”. In this case, image files that include attribute information containing the shooting date/time information that falls within the time period from year 2005, Jan. 1, 9 hours, 1 minute, 1 second to year 2008, Dec. 31, 23 hours, 59 minutes, 59 seconds are the targets of the process of extracting representative colors or reducing the images.

(Display Mode)

There are varieties of display modes, such as a display mode in which the images are laid out in time sequence, and a display mode in which the images are laid out based on the tags attached to the images. Display modes 481 and 482 shown in FIGS. 16A and 16B are respectively a display mode in which the images are laid out in time sequence, and a display mode in which the images are laid out based on the tags attached to the images.

Note that the storage unit 19 does not store all display modes including the two display modes shown in FIGS. 16A and 16B, but stores only one display mode temporarily, and only the stored display mode is used. However, not limited to this, the storage unit 19 may store all display modes including the two display modes shown in FIGS. 16A and 16B, and one of the display modes may be used temporarily.

(Separation Type)

Separation type indicates how two or more types of representative colors are applied in a same display unit region. FIGS. 17A through 17D show typical separation types.

(i) The separation type 483 shown in FIG. 17A indicates that, when two or more types of representative colors are applied in a same display unit region, the display unit region is segmented by a border line into a plurality of regions, and respective representative colors are applied to the plurality of regions.

This type of separation is called a separation by border line.

More specifically, this indicates that, when the representative colors are to be applied separately for the subject image region and the background image region, as shown in FIG. 8A, a display unit region 390 is segmented by a border line 393 into a rectangular internal region 392 and an external region 391, and the representative color of the background image region is applied to the external region 391, and the representative color of the subject image region is applied to the internal region 392.

Also, this indicates that, when the representative colors are to be applied separately for the images shot in the ordinary state and the images shot in the extraordinary state, as shown in FIG. 8B, a display unit region 400 is segmented by a border line 403 into two regions 401 and 402. The representative color of images shot in the ordinary state is applied to the region 402, and the representative color of images shot in the extraordinary state is applied to the region 401.

(ii) The separation type 484 shown in FIG. 17B indicates that, when two or more types of representative colors are applied in a same display unit region, the following type of separation is used.

This type of separation is called a separation by gradation A.

That is to say, a display unit region is segmented by a border line into a rectangular internal region and an external region. Then a border region is formed to have a predetermined width on either side of the borderline. Two representative colors are applied respectively to the two representative color regions that exist respectively outside and inside the border region within a display unit region. Intermediate colors are then applied to the border region so that the colors smoothly change gradually from the first representative color applied to the first representative color region to the second representative color applied to the second representative color region. Note that such application of colors so that the colors smoothly change gradually from the first color to the second color is called application by gradation.

More specifically, this indicates that, when the representative colors are to be applied separately for the subject image region and the background image region, as shown in FIG. 30C, a display unit region 610 is segmented by a border line 614 into a rectangular internal region and an external region. Then a border region 612 is formed to have a predetermined width on either side of the border line 614. Representative colors of the background image region and the subject image region are applied to representative color regions 611 and 613 that exist respectively outside and inside the border region 612 within a display unit region 610. Intermediate colors are then applied to the border region 612 so that the colors smoothly change gradually from the first representative color applied to the first representative color region 611 to the second representative color applied to the second representative color region 613.

Also, this indicates that, when the representative colors are to be applied separately for the images shot in the ordinary state and the images shot in the extraordinary state, as shown in FIG. 30A, a display unit region 590 is segmented by a border line 595 into upper and lower regions. Then a border region 593 is formed to have a predetermined width on either side of the border line 595. Representative colors of images shot in the ordinary state and images shot are applied to representative color regions 591 and 592 that exist respectively on the upper and lower sides of the border region 593 within a display unit region 590. Intermediate colors are then applied to the border region 593 so that the colors smoothly change gradually from the first representative color applied to the first representative color region 591 to the second representative color applied to the second representative color region 592.

(iii) The separation type 485 shown in FIG. 17C indicates that, when two or more types of representative colors are applied in a same display unit region, the following type of separation is used.

This type of separation is almost the same as the separation type 484 shown in FIG. 17B, but slightly differ therefrom as described in the following.

This type of separation is called a separation by gradation B.

According to the separation type 484 shown in FIG. 17B, a display unit region is segmented by a border line into two regions, then a border region is formed to have a predetermined width on either side of the border line. In contrast to this, in the separation type 485 shown in FIG. 17C, the width of the border region changes as follows.

That is to say, for example, when the switch between the ordinary state and the extraordinary state occurs frequently in a predetermined time period, the width of the border region is increased to represent with a gentle gradation that the two conditions are mingled; and when the switch between the ordinary state and the extraordinary state occurs less frequently, namely, when, for example, the ordinary state continues for a long time, and then the extraordinary state continues for a long time, the width of the border region is decreased to represent with a steep gradation that the two conditions are separated.

More specifically, this indicates that, when the representative colors are to be applied separately for the images shot in the ordinary state and the images shot in the extraordinary state, as shown in FIG. 30B, a display unit region 600 is segmented by a border line 606 into upper and lower regions. Then a border region 603 is formed to have a variable width on either side of the border line 606. Representative colors of images shot in the ordinary state and images shot are applied to representative color regions 601 and 602 that exist respectively on the upper and lower sides of the border region 603 within a display unit region 600. Intermediate colors are then applied to the border region 603 so that the colors smoothly change gradually from the first representative color applied to the first representative color region 601 to the second representative color applied to the second representative color region 602.

Also, similarly, when the representative colors are applied to the subject image region and the background image region separately, as shown in FIG. 30D, a display unit region 620 is segmented by a border line 624 into a rectangular internal region and an external region. Then a border region 622 is formed to have a predetermined width on either side of the border line 624. Representative colors of the background image region and the subject image region are applied to representative color regions 621 and 623 that exist respectively outside and inside the border region 622 within the display unit region 620. Intermediate colors are then applied to the border region 622 so that the colors smoothly change gradually from the first representative color applied to the first representative color region 621 to the second representative color applied to the second representative color region 623.

(iv) The separation type 486 shown in FIG. 17D indicates that, when two or more types of representative colors are applied in a same display unit region, the separation methods shown in FIGS. 8C and 8D are used, for example.

This type of separation is called a separation by dispersion layout.

That is to say, when the switch between the ordinary state and the extraordinary state occurs frequently, as shown in FIG. 8C, a large number of extraordinary regions 412, . . . , 416 may be laid out, and the representative colors may be applied to represent that the two conditions are mingled; and when the switch between the ordinary state and the extraordinary state occurs less frequently, as shown in FIG. 8D, a small number of extraordinary regions, namely, an extraordinary region 422 in this example may be laid out, and the representative colors may be applied to represent that the two conditions are separated from each other.

It is presumed here that a sum of areas of the extraordinary regions 412, . . . , 416 shown in FIG. 8C is equivalent with the area of the extraordinary region 422 shown in FIG. 8D.

(Browsing Mode)

There are two browsing modes as shown in FIGS. 18A and 18B: a thumbnail browsing mode 487; and a representative color browsing mode 488. The thumbnail browsing mode 487 is a display mode in which a plurality of reduced images are displayed in alignment; and the representative color browsing mode 488 is a display mode in which a plurality of representative colors are displayed in alignment.

(Classification Table)

The classification table is a data table that shows the data structures of one or more groups that are generated by the image classifying unit 10 by classifying a plurality of image files stored in the storage unit 52 of the recording device 5, by using a classification key. Each group includes one or more image files, and a plurality of image files constituting a group have one or more same attribute values in common.

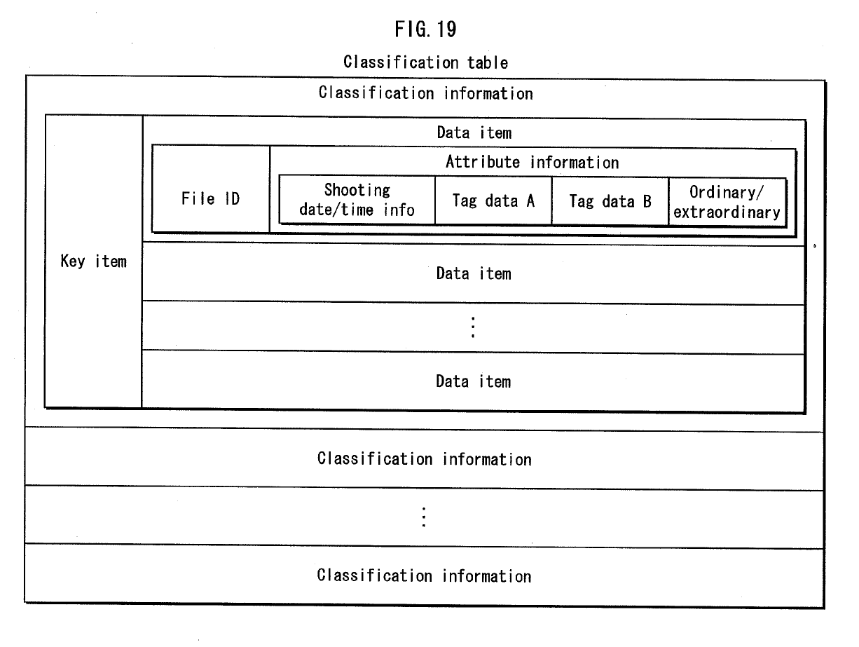

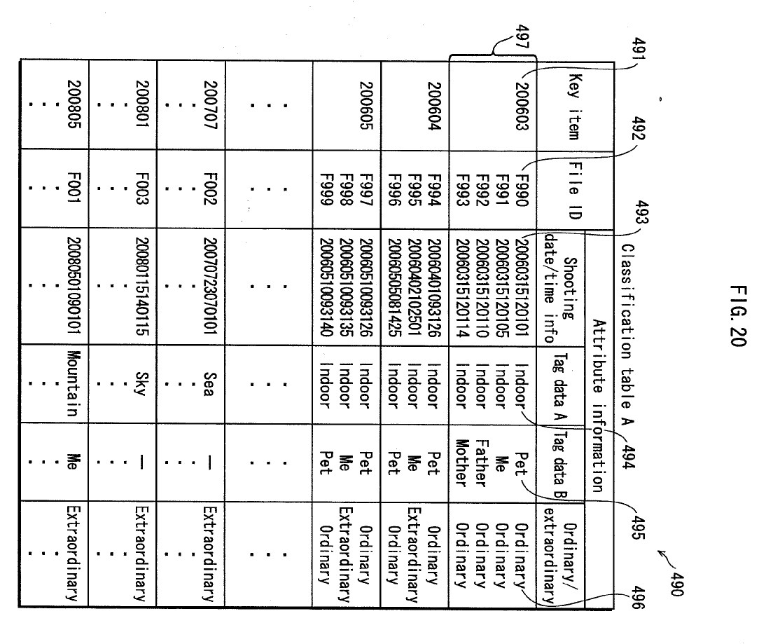

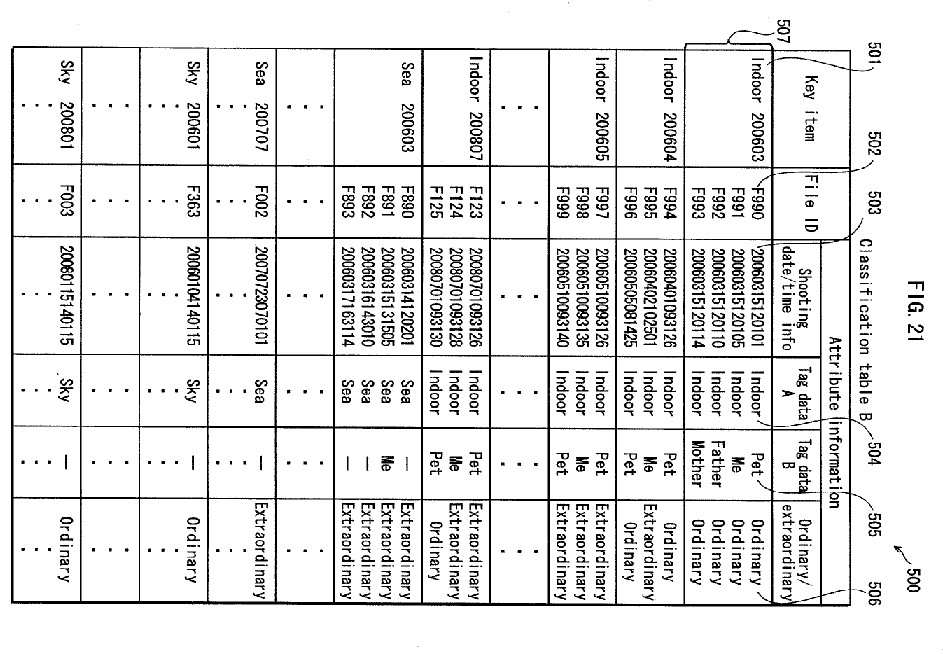

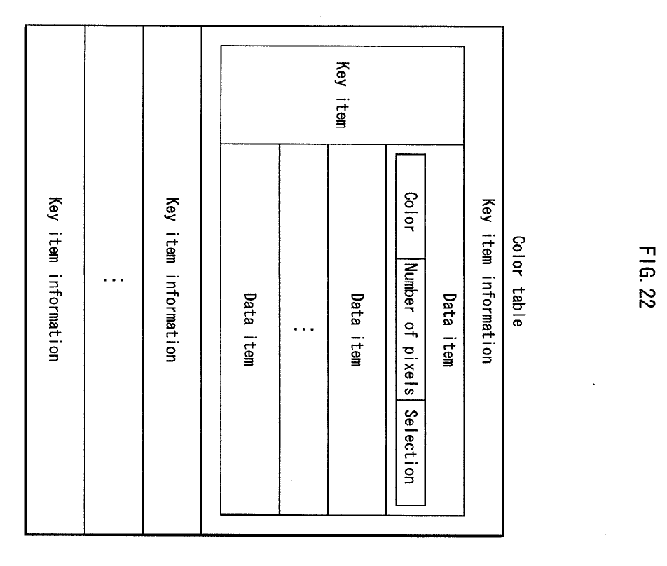

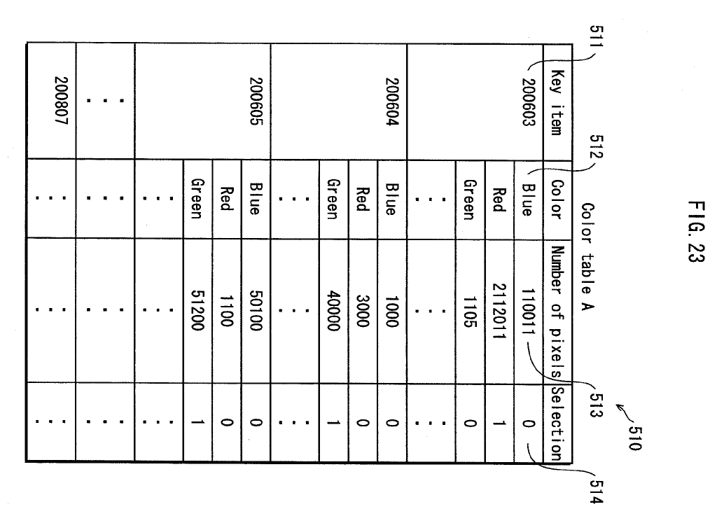

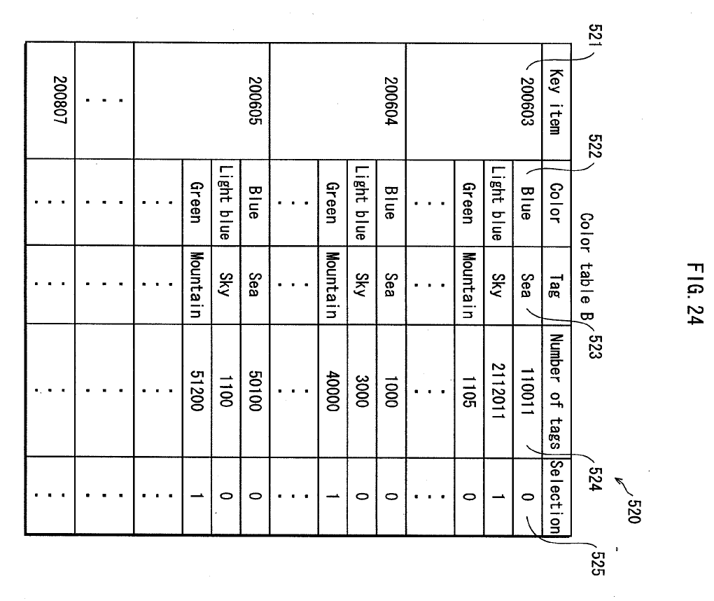

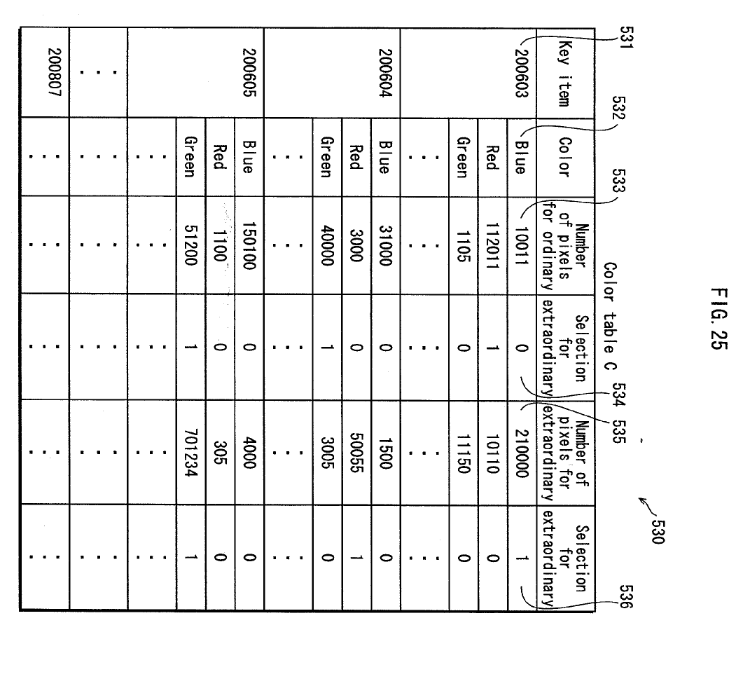

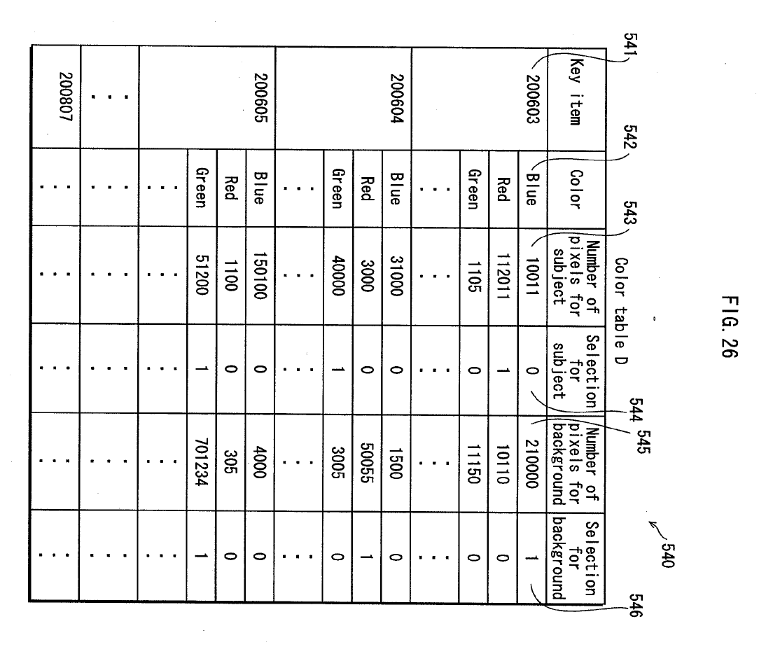

The classification table is composed of a plurality of pieces of classification information, where the data structure of the classification table is shown in FIG. 19, and examples thereof are shown in FIGS. 20 and 21. Each piece of classification information corresponds to a group generated by the image classifying unit 10.

Each piece of classification information is composed of a key item and one or more data items. The key item corresponds to a classification key among the items of the attribute information contained in all image files included in the group that corresponds to the piece of classification information. The data items correspond to image files image files included in the group that corresponds to the piece of classification information. Each data item includes a file ID and attribute information. The file ID and attribute information are the file ID and attribute information of the image files that correspond to the data items, respectively. The attribute information includes either date/time information, tag data A, and tag data B; or date/time information, tag data A, tag data B, and ordinary/extraordinary distinction.

A classification table A 490 shown in FIG. 20 is an example of the table generated by the image classifying unit 10 by using classification key “year, month”.

The classification table A 490 includes classification information 497 and other pieces of classification information. The classification information 497 is composed of a key item 491 and one or more data items. In this example, the key item 491 is “200603”. Therefore, the classification information 497 corresponds to image files including “200603” as year and month in the shooting date/time information.

A classification table B 500 shown in FIG. 21 is an example of the table generated by the image classifying unit 10 by using classification key “tag data, year, month”.

The classification table B 500 includes classification information 507 and other pieces of classification information. The classification information 507 is composed of a key item 501 and one or more data items. In this example, the key item 501 is “indoor 200603”. Therefore, the classification information 507 corresponds to image files including tag data A “indoor” and “200603” as year and month in the shooting date/time information.

Note that the storage unit 19 temporarily stores only one classification table.

(Color Table)

The color table is a data table that is generated when the representative color extracting unit 11 determines the representative color. As shown in FIGS. 23-26, there are four types of color tables: color table A 510; color table B 520; color table C 530; and color table D 540. FIG. 22 shows one example of the data structure of the color table A.

(i) Color Table A 510

The color table A 510 is a table that is used when representative colors are extracted from images and the representative color extracting unit 11 determines the representative color.

The color table A 510, as shown in FIGS. 22 and 23, is composed of a plurality of pieces of key item information. Each piece of key item information corresponds to the classification information included in the classification table.

Each piece of key item information includes a key item and a plurality of data items. Here, the data items correspond to colors extracted from images. The data items are “color”, “number of pixels”, and “selection”. The data item “color” indicates a color extracted from an image. The data item “number of pixels” indicates the number of pixels based on which the color is extracted. The data item “selection” indicates whether the color was selected as the representative color. When the data item “selection” is “1”, it indicates that the color was selected; and when the data item “selection” is “0”, it indicates that the color was not selected.

(ii) Color Table B 520

The color table B 520 is a table that is used when the representative color extracting unit 11 determines the representative color based on the tag.

The color table B 520, as shown in FIG. 24, is composed of a plurality of pieces of key item information. Each piece of key item information corresponds to the classification information included in the classification table.

Each piece of key item information includes a key item and a plurality of data items. Here, the data items correspond to colors extracted from images. The data items are “color”, “tag”, “number of tags”, and “selection”. The data item “color” indicates a color extracted from an image. The data item “tag” indicates a tag attached to the image file. The data item “number of tags” indicates the number of image files to which tags are attached. The data item. “selection” indicates whether the color was selected as the representative color. When the data item “selection” is “1”, it indicates that the color was selected; and when the data item “selection” is “0”, it indicates that the color was not selected.

Note that the color tables A 510 and B 520 differ from each other in that the color table A 510 includes data item “number of pixels”, while the color table B 520 includes data items “tag” and “number of tags”.

(iii) Color Table C 530

The color table C 530 is a table that is used when the representative color extracting unit 11 determines the representative color when there is a distinction between ordinary and extraordinary.

The color table C 530, as shown in FIG. 25, is composed of a plurality of pieces of key item information. Each piece of key item information corresponds to the classification information included in the classification table.

Each piece of key item information includes a key item and a plurality of data items. Here, the data items correspond to colors extracted from images. The data items are “color”, “number of pixels for ordinary”, “selection for ordinary”, “number of pixels for extraordinary”, and “selection for extraordinary”. The data item “color” indicates a color extracted from an image. The data item “number of pixels for ordinary” indicates the number of pixels based on which the color is extracted from the image that was shot in the ordinary state. The data item “selection for ordinary” indicates whether the color was selected as the representative color. The data item “number of pixels for extraordinary” indicates the number of pixels based on which the color is extracted from the image that was shot in the extraordinary state. The data item “selection for extraordinary” indicates whether the color was selected as the representative color. When the data item “selection for ordinary” is “1”, it indicates that the color was selected; and when the data item “selection for ordinary” is “0”, it indicates that the color was not selected. This also applies to the data item “selection for extraordinary”.

Note that the color tables A 510 and C 530 differ from each other in that the color table A 510 includes data items “number of pixels” and “selection” for each color whether there is a distinction between ordinary and extraordinary, while the color table C 530 includes data items “number of pixels” and “selection” for each color and for each of “ordinary” and “extraordinary”.

(iv) Color Table D 540

The color table D 540 is a table that is used when the representative color extracting unit 11 determines the representative color when the images include a subject and a background.

The color table D 540, as shown in FIG. 26, is composed of a plurality of pieces of key item information. Each piece of key item information corresponds to the classification information included in the classification table.

Each piece of key item information includes a key item and a plurality of data items. Here, the data items correspond to colors extracted from images. The data items are “color”, “number of pixels for subject”, “selection for subject”, “number of pixels for background”, and “selection for background”. The data item “color” indicates a color extracted from an image. The data item “number of pixels for subject” indicates the number of pixels based on which the color is extracted from the subject portion of the image. The data item “selection for subject” indicates whether the color was selected as the representative color. The data item “number of pixels for background” indicates the number of pixels based on which the color is extracted from the background portion of the image. The data item “selection for background” indicates whether the color was selected as the representative color. When the data item “selection for subject” is “1”, it indicates that the color was selected; and when the data item “selection for subject” is “0”, it indicates that the color was not selected. This also applies to the data item “selection for background”.

Note that the color tables A 510 and D 540 differ from each other in that the color table A 510 includes data items “number of pixels” and “selection” for each color regardless of the difference between “subject” and “background”, while the color table D 540 includes data items “number of pixels” and “selection” for each color and for each of “subject” and “background”.

(Browsing Mode Switch Types)

There are browsing mode switch types “A” and “B”, either of which is set.

The switch type “A” indicates which of the representative color list screen and the thumbnail list screen should be displayed, based on the result of comparison between the number of images and the threshold value.

The switch type “B” indicates which of the representative color list screen and the thumbnail list screen should be displayed, based on whether or not all the target images exist in the standard time period.

(Color Correspondence Table A)

A color correspondence table A 300, as shown in FIG. 2A, is a data table which indicates correspondence between image tags and colors. For example, an image tag “sea” 301 is correlated with a color “blue” 302.

(Color Correspondence Table B)

A color correspondence table B 310, as shown in FIG. 2B, is a data table which indicates correspondence between image tags and colors. For example, an image tag “me” 311 is correlated with a color “blue” 312.

(Ordinary/Extraordinary State Switched/Fixed Display Flag)

An ordinary/extraordinary state switched/fixed flag is a flag that indicates whether a switched display of the ordinary state and the extraordinary state is performed, or a fixed display of either the ordinary state or the extraordinary state is performed.

When the flag indicates that the switched display of the ordinary state and the extraordinary state is performed, the switched display of the ordinary state and the extraordinary state is performed; and when the flag indicates that the fixed display of either the ordinary state or the extraordinary state is performed, either the ordinary state or the extraordinary state is displayed.

(5) Ordinary/Extraordinary Setting Unit 14, Browsing Range Setting Unit 30, Information Setting Unit 32

The ordinary/extraordinary setting unit 14 receives, from the user, for each image file stored in the storage unit 52 of the recording device 5, distinction between “ordinary” and “extraordinary”, namely, which of the ordinary and extraordinary states, the image file should be classified as belonging to. Also, the ordinary/extraordinary setting unit 14 sends an instruction to the recording device 5, via the input/output unit 18, to set the received distinction in the attribute information of the image file stored in the storage unit 52 of the recording device 5.

Also, the browsing range setting unit 30 receives specification of a browsing range from the user, and writes browsing range information including the received specification of the browsing range into the storage unit 19.

The information setting unit 32 receives, from the user, specification of a display mode, classification key, units of vertical and horizontal axes, classification period, browsing mode switch type, operation pattern, application of colors separately for subject and background, and separation type, and writes, into the storage unit 19, the received specification of a display mode, classification key, units of vertical and horizontal axes, classification period, browsing mode switch type, operation pattern, application of colors separately for subject and background, and separation type.

(6) Browsing Mode Switching Unit 31

The browsing mode switching unit 31 reads out the browsing mode switch type from the storage unit 19, judges whether the read-out browsing mode switch type is “A” or “B”.

As described earlier, the switch type “A” indicates which of the representative color list screen and the thumbnail list screen should be displayed, based on the result of comparison between the number of images and the threshold value. The switch type “B” indicates which of the representative color list screen and the thumbnail list screen should be displayed, based on whether or not all the target images exist in the standard time period.

When the browsing mode switch type is “A”, the browsing mode switching unit 31 sets the browsing mode to “representative color” when the number of image files to be displayed on the list screen is greater than the threshold value; and the browsing mode switching unit 31 sets the browsing mode to “thumbnail” when the number of image files to be displayed on the list screen is equal to or smaller than the threshold value.

When the browsing mode switch type is “B”, the browsing mode switching unit 31 sets the browsing mode to “thumbnail” when all shooting dates/times of all the image files to be displayed on the list screen are within the standard period; and the browsing mode switching unit 31 sets the browsing mode to “representative color” when any one of shooting dates/times of all the image files to be displayed on the list screen is without the standard period.

(7) Image Classifying Unit 10

The image classifying unit 10 reads out the classification key from the storage unit 19. Examples of the classification key are shown in FIGS. 12A through 12B.

After this, the image classifying unit 10 reads out, from the recording device 5, the file IDs and attribute information (shooting date/time information, tag data A, tag data B) of all the image files indicated by the browsing range information stored in the storage unit 19, classifies all the read-out sets of file ID and attribute information in accordance with the classification key read out from the storage unit 19, and writes the sets of file ID and attribute information after the classification into the storage unit 19 as the classification table.

Examples of the classification table are shown in FIGS. 20 and 21.

(8) Representative Color Extracting Unit 11

The representative color extracting unit 11 reads out the operation pattern information from the storage unit 19. Examples of the operation pattern information are shown in FIG. 14A through 14E.

Next, the representative color extracting unit 11 operates as follows depending on the content of the read-out operation pattern information.

(a) When the content of the read-out operation pattern information is “no distinction between ordinary and extraordinary” and the display mode stored in the storage unit 19 is “mode in which images are laid out on the time axis”, the representative color extracting unit 11 performs the process of determining the representative colors based on the tags, which will be described later.

When the content of the read-out operation pattern information is “no distinction between ordinary and extraordinary” and the display mode stored in the storage unit 19 is “mode in which images are laid out by tags”, the representative color extracting unit 11 performs the process of extracting the representative colors from the image data, which will be described later.

(b) When the content of the read-out operation pattern information is “extract extraordinary”, the representative color extracting unit 11 performs the process of extracting the representative colors from the extraordinary image data, which will be described later.

(c) When the content of the read-out operation pattern information is “apply colors separately for ordinary and extraordinary” or “switch with distinction between ordinary and extraordinary”, the representative color extracting unit 11 performs the process of extracting the representative colors for each of ordinary and extraordinary, which will be described later.

(d) When the content of the read-out operation pattern information is “apply colors separately for subject and background”, the representative color extracting unit 11 performs the process of extracting the representative colors for each of subject and background, which will be described later.

Now, the description is given of how the representative color extracting unit 11 extracts representative colors.

(a) Extracting Representative Colors from Image Data

The following describes how the representative color extracting unit 11 extracts representative colors from image data in detail.

The representative color extracting unit 11 repeats the following steps 1 through 6 for each of the file IDs included in the classification table (as one example, the classification table A 490 shown in FIG. 20, or the classification table B 500 shown in FIG. 21) stored in the storage unit 19.

(Step 1) The representative color extracting unit 11 reads out a file ID and a key item corresponding to the file ID, from the classification table stored in the storage unit 19.

(Step 2) The representative color extracting unit 11 reads out, from the storage unit 52 of the recording device 5, compressed image data of the image file identified by the read-out file ID.

(Step 3) The representative color extracting unit 11 extends the read-out compressed image data and generates image data that is composed of a plurality of pixels. Here, when the image file is, for example, in the JPEG (Joint Photographic Experts Group) format, the representative color extracting unit 11 generates the image data through processes such as decoding of variable-length code, inverse quantization, and inverse DCT (Discrete Cosine Transform).

(Step 4) The representative color extracting unit 11 extracts colors of all the pixels from the generated image data. In the following, it is described in detail how the color of each pixel is extracted.

It is presumed here that the color for each pixel extracted by the representative color extracting unit 11 is any of the 10 colors: black, purple, blue, light blue, green, yellowish green, yellow, orange, red, and white. It should be noted here that, not limited to these colors, the number of the types of colors that can be extracted may be greater or smaller than 10. These types of colors are called standard colors. Suppose that the color space is represented by the RGB color model, and each of R, G, and B is assigned with four bits, then a total of 4096 colors can be represented. Each of the 4096 colors is assigned to one of the standard colors. Note that this assignment is subjective. After each of the 4096 colors is assigned to one of the standard colors, a range of values of R, G, and B is determined for each standard color. This is called color range of the standard color.

The representative color extracting unit 11 converts, for each pixel, the brightness and two color differences of a pixel to respective values of R, G, and B by using the conversion equations for conversion from brightness and color difference to RGB. The representative color extracting unit 11 than judges what color range the obtained combination of the R, G, and B values falls in, among the above-described color ranges of the plurality of standard colors. After this, the representative color extracting unit 11 determines the standard color corresponding to the color range judged here, as the color of the pixel.

(Step 5) The representative color extracting unit 11 counts the number of pixels for each color.

(Step 6) The representative color extracting unit 11 generates the color table A 510 shown in FIG. 23, and in the color table A 510, adds up the numbers of pixels of the colors for each key item. [End of steps]

When one round of steps 1 through 6 ends, the representative color extracting unit 11 selects, for each key item in the color table A 510, a color that corresponds to the largest number of pixels, determines the selected colors as the representative colors, and sets the data item “selection” of each selected color to “1”, in the color table A 510. In this way, the representative colors are determined.

(b) Extracting Representative Colors from Tags

The following describes how the representative color extracting unit 11 extracts representative colors from tags in detail.

The representative color extracting unit 11 repeats the following steps 1 through 3 for each of the key items included in the classification table stored in the storage unit 19.

(Step 1) The representative color extracting unit 11 reads out all pieces of tag data A that are associated with a same key item, from the classification table.

(Step 2) The representative color extracting unit 11 counts the number of pieces of tag data A that indicate the same tag, for each tag indicated by the read-out all pieces of tag data A, and writes the counted numbers of pieces of tag data A for each tag content in each key item in the color table B 520 shown in FIG. 24.

(Step 3) The representative color extracting unit 11 selects a color that corresponds to a tag having the largest counted number for each key item in the color table B 520, determines the selected color as the representative color, and sets the data item “selection” of each selected color to “1”, in the color table B 520.

[End of Steps]

(c) Extracting Representative Colors from Extraordinary Image Data

The following describes how the representative color extracting unit 11 extracts representative colors from extraordinary image data.

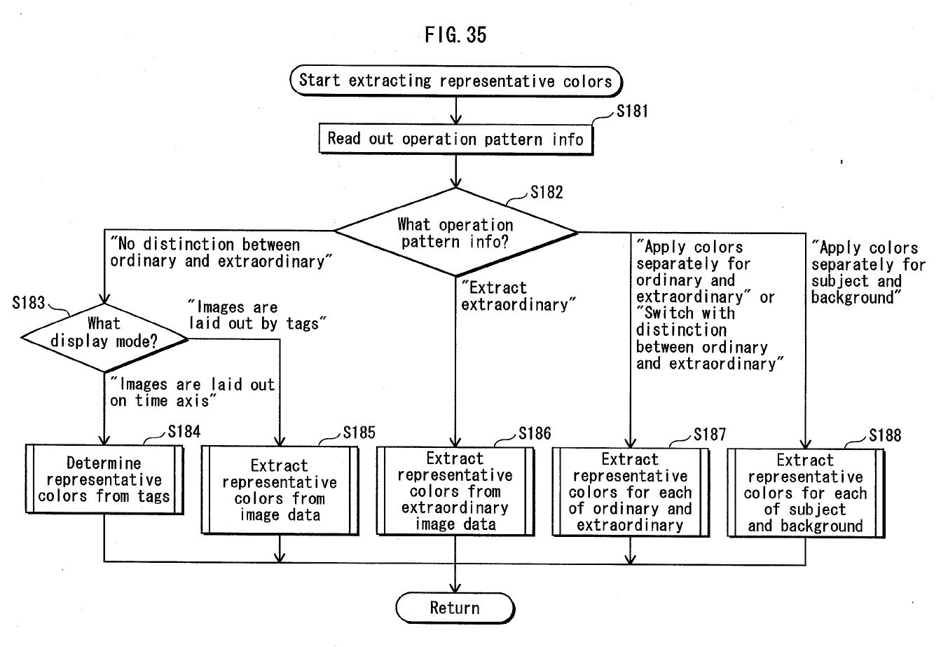

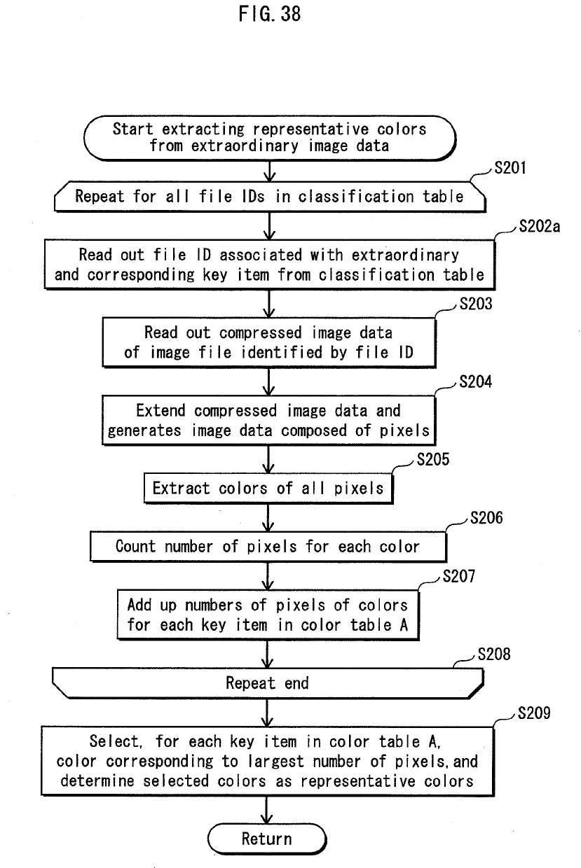

Now, the detail of the operation for extracting representative colors from the extraordinary image data, the process indicated in step S186 shown in FIG. 35, will be described with reference to the flowchart shown in FIG. 38.

The representative color extracting unit 11 repeats the following steps 1 through 6 for each of the file IDs included in the classification table stored in the storage unit 19.

(Step 1) The representative color extracting unit 11 reads out a file ID associated with the extraordinary and a key item corresponding to the file ID, from the classification table stored in the storage unit 19.

(Step 2) The representative color extracting unit 11 reads out, from the recording device 5, compressed image data of the image file identified by the read-out file ID.

(Step 3) The representative color extracting unit 11 extends the read-out compressed image data and generates image data that is composed of a plurality of pixels.

(Step 4) The representative color extracting unit 11 extracts colors of all the pixels from the generated image data.

(Step 5) The representative color extracting unit 11 counts the number of pixels for each color.

(Step 6) The representative color extracting unit 11, in the color table A 510 shown in FIG. 23, adds up the counted numbers of pixels of the colors for each key item.

[End of Steps]

When the performance of steps 1 through 6 is repeated for each of all file IDs included in the classification table stored in the storage unit 19, the representative color extracting unit 11 selects, for each key item in the color table A 510, a color that corresponds to the largest number of pixels, determines the selected colors as the representative colors, and sets the data item “selection” of each selected color to “1”, in the color table A 510.

(d) Extracting Representative Colors from Each of Ordinary and Extraordinary Image Data

The following describes how the representative color extracting unit 11 extracts representative colors from each of ordinary and extraordinary image data.

The representative color extracting unit 11 repeats the following steps 1 through 6 for each of the file IDs included in the classification table stored in the storage unit 19.

(Step 1) The representative color extracting unit 11 reads out a file ID and a key item corresponding to the file ID, from the classification table stored in the storage unit 19.

(Step 2) The representative color extracting unit 11 reads out, from the recording device 5, compressed image data of the image file identified by the read-out file ID.

(Step 3) The representative color extracting unit 11 extends the read-out compressed image data and generates image data that is composed of a plurality of pixels.

(Step 4) The representative color extracting unit 11 extracts colors of all the pixels from the generated image data.

(Step 5) The representative color extracting unit 11 counts the number of pixels for each color.

(Step 6) The representative color extracting unit 11, in the color table C 530 shown in FIG. 25, adds up the counted numbers of pixels of the colors for each key item, and for each of the ordinary and the extraordinary. [End of steps]

When the performance of steps 1 through 6 is repeated for each of all file IDs included in the classification table stored in the storage unit 19, the representative color extracting unit 11 selects, for each of ordinary and extraordinary and for each key item in the color table C 530, a color that corresponds to the largest number of pixels, determines the selected colors as the representative colors, and sets the data item “selection” of each selected color to “1”, in the color table C 530.

(e) Extracting Representative Colors from Image Data for Each of Subject and Background

The following describes how the representative color extracting unit 11 extracts representative colors from image data for each of subject and background.

The representative color extracting unit 11 repeats the following steps 1 through 6 for each of the file IDs included in the classification table stored in the storage unit 19.

(Step 1) The representative color extracting unit 11 reads out a file ID and a key item corresponding to the file ID, from the classification table stored in the storage unit 19.

(Step 2) The representative color extracting unit 11 reads out, from the recording device 5, compressed image data of the image file identified by the read-out file ID.

(Step 3) The representative color extracting unit 11 extends the read-out compressed image data and generates image data that is composed of a plurality of pixels.

(Step 4) The representative color extracting unit 11 extracts colors of all the pixels from the generated image data.

(Step 5) The representative color extracting unit 11 counts the number of pixels for each color.

(Step 6) The representative color extracting unit 11, in the color table D 540 shown in FIG. 26, adds up the counted numbers of pixels of the colors for each key item, and image data for each of subject and background. [End of steps]

When the performance of steps 1 through 6 is repeated for each of all file IDs included in the classification table stored in the storage unit 19, the representative color extracting unit 11 selects, for each of subject and background and for each key item in the color table D 540, a color that corresponds to the largest number of pixels, determines the selected colors as the representative colors, and sets the data item “selection” of each selected color to “1”, in the color table D 540.

(9) Representative Color Layout Unit 12 and Representative Color Switching Unit 16

(Representative Color Layout Unit 12)

The representative color layout unit 12 reads out axis information from the storage unit 19, draws the horizontal and vertical axes on the list screen to be displayed, draws the scale on the horizontal and vertical axes, and, based on the read-out axis information, draws values on the scales of the horizontal and vertical axes.

Next, the representative color layout unit 12 repeats the following steps S1 to S2 for each key item included in the color table stored in the storage unit 19.

(Step 1) The representative color layout unit 12 reads out, from the color table (the color table A, B, or C) stored in the storage unit 19, key items and determined colors in order. It should be noted here that the determined colors are colors for which the data item “selection” has been set to “1” in the color table. Here, when it receives an ordinary state display instruction from the representative color switching unit 16, the representative color layout unit 12 uses colors that are indicated as representative colors by the data item “selection for ordinary” in the color table C, based on the received ordinary state display instruction; and when it receives an extraordinary state display instruction from the representative color switching unit 16, the representative color layout unit 12 uses colors that are indicated as representative colors by the data item “selection for extraordinary” in the color table C, based on the received extraordinary state display instruction.

(Step 2) The representative color layout unit 12 draws the determined colors on the screen to be displayed, at the positions corresponding to the key items. [End of steps]

The representative color layout unit 12 reads out the separation type from the storage unit 19.

When the read-out separation type is “border line”, the representative color layout unit 12 determines a drawing position of the border line in the display unit region based on a ratio between the number of images shot in the ordinary state and the number of images shot in the extraordinary state. The representative color layout unit 12 then applies different colors to both sides of the border line in the display unit region, respectively. Examples of the display unit region applied with different colors in this way are shown in FIGS. 8A and 8B.

When the read-out separation type is “gradation A”, the representative color layout unit 12 determines a drawing position of the border line in the display unit region based on a ratio between the number of images shot in the ordinary state and the number of images shot in the extraordinary state. The representative color layout unit 12 then forms a border region to have a predetermined width on either side of the border line, applies colors by gradation to inside the border region, and applies different colors to both sides of the border region in the display unit region, respectively. Examples of the display unit region applied with different colors in this way are shown in FIGS. 30A and 30B.

When the read-out separation type is “gradation B”, the representative color layout unit 12 determines a drawing position of the border line in the display unit region based on a ratio between the number of images shot in the ordinary state and the number of images shot in the extraordinary state. The representative color layout unit 12 then forms a border region to have a predetermined width on either side of the border line, where each width of the border region varies depending on the level of change between the images shot in the ordinary state and the images shot in the extraordinary state, namely, depending on whether the change is gentle or steep. The representative color layout unit 12 then applies colors by gradation to inside the border region, and applies different colors to both sides of the border region in the display unit region, respectively. Examples of the display unit region applied with different colors in this way are shown in FIGS. 30A through 30D.

When the read-out separation type is “dispersion layout”, the representative color layout unit 12 determines a ratio in area between the background region and the extraordinary region in the display unit region, in accordance with a ratio between the number of images shot in the ordinary state and the number of images shot in the extraordinary state. The representative color layout unit 12 determines the number of dispersions based on the level of change between the images shot in the ordinary state and the images shot in the extraordinary state, namely, depending on whether the change is gentle or steep. The representative color layout unit 12 then applies different colors to the background region and the extraordinary region in the display unit region, respectively. Examples of the display unit region applied with different colors in this way are shown in FIGS. 8C and 8D.

(Representative Color Switching Unit 16)

representative color switching unit 16, before the representative color layout unit 12 lays out the list screen, judges whether the switch between the ordinary state and the extraordinary state is stored in the storage unit 19. When the switch is stored in the storage unit 19, the representative color switching unit 16 sets an initial value inside to display the ordinary state, and instructs the representative color layout unit 12 to display the ordinary state.

When the performance of the above-described steps 1 through 2 is repeated by the representative color layout unit 12 for each of all key items included in the color table stored in the storage unit 19, the representative color switching unit 16 judges whether there is a switch between the ordinary state and the extraordinary state.

When there is a switch between the ordinary state and the extraordinary state, the representative color switching unit 16 controls the display unit 17 to display, on the screen, a button for a switch between the ordinary state and the extraordinary state. Under this control, the display unit 17 displays the button on the screen. Further, the representative color switching unit 16 waits for a switch instruction to be input by the user. When it receives the switch instruction, the representative color switching unit 16 switches from the current setting to the other setting, namely, from “ordinary” to “extraordinary”, or from “extraordinary” to “ordinary”. Furthermore, when it switches the setting to “extraordinary”, the representative color switching unit 16 instructs the representative color layout unit 12 to perform for “extraordinary”, and when it switches the setting to “ordinary”, the representative color switching unit 16 instructs the representative color layout unit 12 to perform for “ordinary”.

When the representative color switching unit 16 waits for a switch instruction to be input by the user and there is no input of the switch instruction, the representative color switching unit 16 causes the representative color layout unit 12 to end the processing.

(10) Reduced Image Generating Unit 20, Reduced Image Layout Unit 21

The reduced image generating unit 20 repeats the following steps 1 through 4 for each of the file IDs included in the classification table (for example, the classification table A 490 shown in FIG. 20, or the classification table B 500 shown in FIG. 21) stored in the storage unit 19.

(Step 1) The reduced image generating unit 20 reads out a file ID from the classification table stored in the storage unit 19.

(Step 2) The reduced image generating unit 20 reads out, from the storage unit 52 of the recording device 5, compressed image data of the image file identified by the read-out file ID.

(Step 3) The reduced image generating unit 20 extends the read-out compressed image data and generates image data that is composed of a plurality of pixels.

(Step 4) The reduced image generating unit 20 generates reduced images from the generated image data, and outputs the generated reduced images to the reduced image layout unit 21.

The reduced image layout unit 21 receives the reduced images from the reduced image generating unit 20 and lays out the received reduced images on the screen.

(11) Display Unit 17, Input/Output Unit 18, Control Unit 22

The display unit 17 displays the list screen.

The input/output unit 18, upon receiving an instruction from another constituent element of the image browsing device 4, reads out an image file from the recording device 5, or outputs information to the recording device 5 so that the information is recorded in the recording device 5.

The control unit 22 controls other constituent elements of the image browsing device 4.

3.4 Operation of Image Browsing Device 4

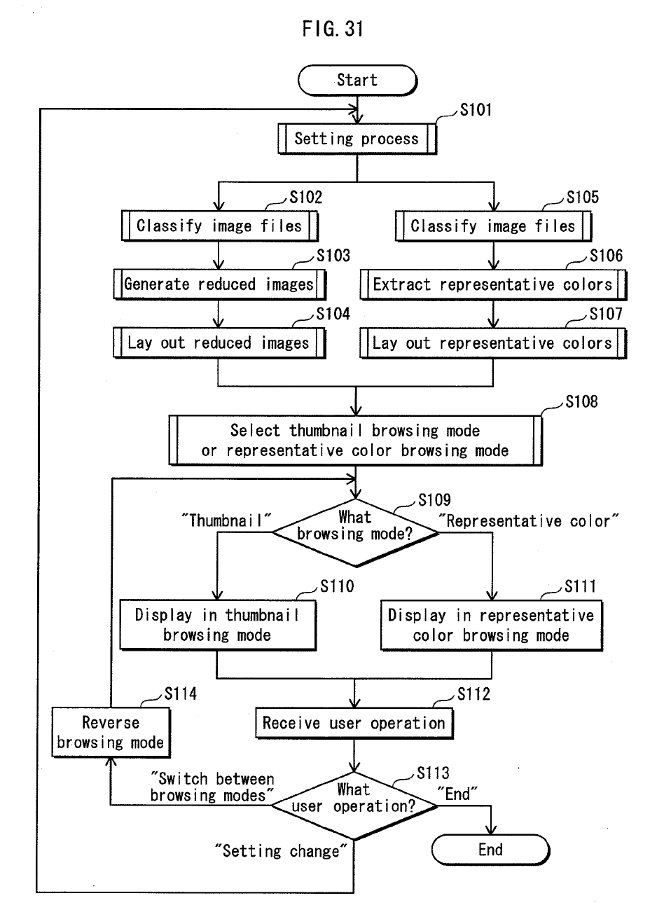

The operation of the image browsing device 4 will be described with reference to the flowcharts shown in FIGS. 31 through 43.

(1) General Operation of Image Browsing Device 4

The general operation of the image browsing device 4 will be described with reference to the flowchart shown in FIG. 31.

Under the control of the control unit 22, the browsing range setting unit 30, the information setting unit 32, and the ordinary/extraordinary setting unit 14 perform the setting process (step S101).

Next, under the control of the control unit 22, the image classifying unit 10 classifies the image files (step S102), the reduced image generating unit 20 generates reduced images (step S103), and the reduced image layout unit 21 lays out the generated reduced images (step S104).

On the other hand, in parallel with steps S102 through 5104, under the control of the control unit 22, the image classifying unit 10 classifies the image files (step S105), the representative color extracting unit 11 extracts representative colors (step S106), and the representative color layout unit 12 lays out the representative colors (step S107).

Next, under the control of the control unit 22, the browsing mode switching unit 31 selects either of the thumbnail browsing mode and the representative color browsing mode (step S108). When the thumbnail browsing mode is selected (step S109), the display unit 17 performs a display in the thumbnail browsing mode (step S110). When the representative color browsing mode is selected (step S109), the display unit 17 performs a display in the representative color browsing mode (step S111).

Next, under the control of the control unit 22, the information setting unit 32 receives a user operation (step S112). When the received user operation indicates an end (step S113), the image browsing device 4 ends the processing. When the received user operation indicates “setting change” (step S113), the control returns to step S101 to repeat the process. When the received user operation indicates “switch between browsing modes” (step S113), the browsing mode is reversed (step S114), and the control returns to step S109 to repeat the process.

(2) Operation of Setting Process

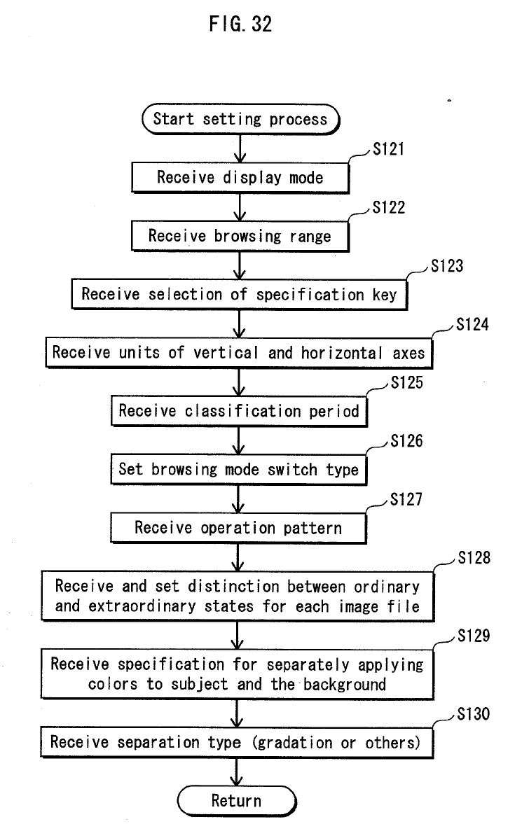

Now, a detailed description is given of the operation of the setting process performed in step S101 of FIG. 31, with reference to the flowchart shown in FIG. 32.

The information setting unit 32 receives specification of a display mode from the user (step S121). The browsing range setting unit 30 receives specification of a browsing range from the user (step S122).

Next, the information setting unit 32 receives specification of a selected specification key from the user (step S123), receives specification of the units of the vertical axis and horizontal axis (step S124), receives specification of a classification period (step S125), receives specification of a browsing mode switch type (step S126), and receives specification of an operation pattern (step S127).

Next, the ordinary/extraordinary setting unit 14 receives a distinction between the ordinary state and the extraordinary state for each image file, and sets the received distinctions in the storage unit 52 of the recording device 5 (step S128).

Next, the information setting unit 32 receives specification for separately applying colors to the subject and the background (step S129), and receives a separation type (step S130).

(3) Operation of Browsing Mode Selecting Process

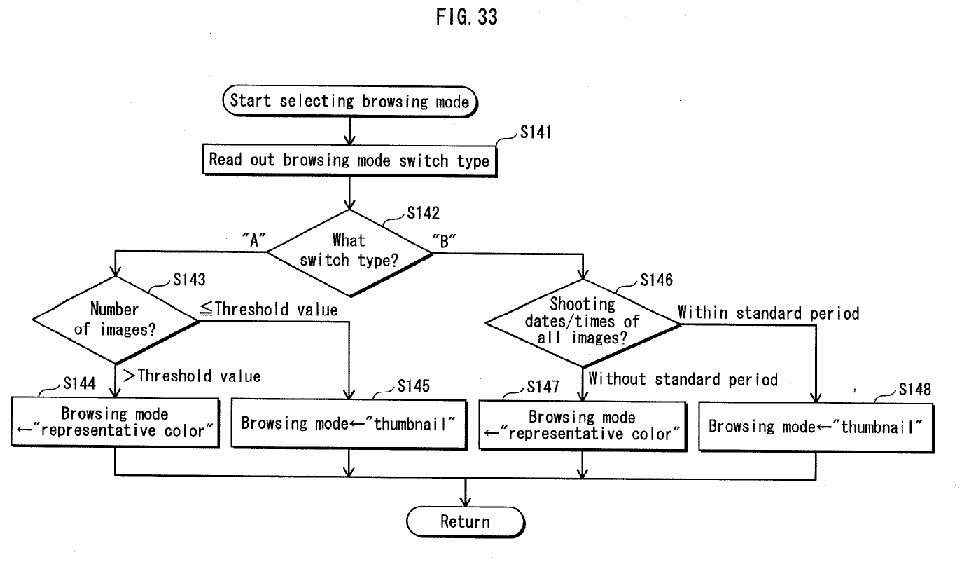

Here, a detailed description is given of the operation of the browsing mode selecting process performed in step S108 of FIG. 31, with reference to the flowchart shown in FIG. 33.

The browsing mode switching unit 31 reads out a browsing mode switch type from the storage unit 19 (step S141).

When the browsing mode switch type is “A” (step S142), the browsing mode switching unit 31 sets the browsing mode to “representative color” when the number of image files to be displayed on the list screen is larger than a threshold value (step S144). On the other hand, the browsing mode switching unit 31 sets the browsing mode to “thumbnail” when the number of image files to be displayed on the list screen is equal to or smaller than the threshold value (step S145).

When the browsing mode switch type is “B” (step S142), the browsing mode switching unit 31 sets the browsing mode to “thumbnail” when shooting dates/times of all image files to be displayed on the list screen are within a standard period (step S148), and the browsing mode switching unit 31 sets the browsing mode to “representative color” when at least one of the shooting dates/times of all image files to be displayed on the list screen is without the standard period (step S147).

(4) Operation of Classifying Image Files

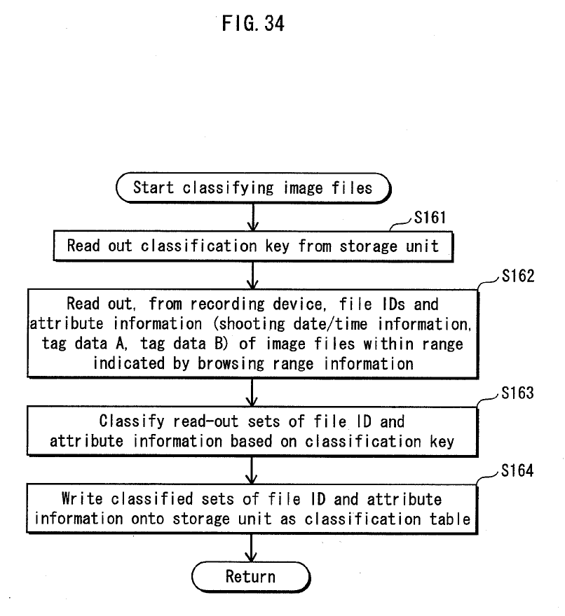

Here, a detailed description is given of the operation of classifying image files performed in steps S102 and 5105 of FIG. 31, with reference to the flowchart shown in FIG. 34.

The image classifying unit 10 reads out a classification key from the storage unit 19 (step S161), reads out, from the recording device 5, file IDs and attribute information (shooting date/time information, tag data A, tag data B) of all image files within the range indicated by the browsing range information stored in the storage unit 19 (step S162). The image classifying unit 10 then classifies all sets of the read-out file ID and attribute information based on the classification key read out from the storage unit 19 (step S163), and writes the classified sets of file ID and attribute information onto the storage unit 19 as a classification table (step S164).

(5) Operation of Extracting Representative Colors

Here, a detailed description is given of the operation of extracting representative colors performed in step S106 of FIG. 31, with reference to the flowchart shown in FIG. 35.

The representative color extracting unit 11 reads out the operation pattern information from the storage unit 19 (step S181). When the read-out operation pattern information indicates “no distinction between ordinary and extraordinary” (step S182), and when the display mode stored in the storage unit 19 is “mode in which images are laid out on the time axis” (step S183), the process of determining representative colors from tags is performed (step S184).

When the read-out operation pattern information indicates “no distinction between ordinary and extraordinary” (step S182), and when the display mode stored in the storage unit 19 is “mode in which images are laid out by tags” (step S183), the representative color extracting unit 11 performs the process of extracting representative colors from the image data (step S185).

When the read-out operation pattern information indicates “extract extraordinary” (step S182), the representative color extracting unit 11 performs the process of extracting the representative colors from the extraordinary image data (step S186).

When the read-out operation pattern information indicates “apply colors separately for ordinary and extraordinary” or “switch with distinction between ordinary and extraordinary” (step S182), the representative color extracting unit 11 performs the process of extracting the representative colors for each of ordinary and extraordinary (step S187).

When the read-out operation pattern information indicates “apply colors separately for subject and background” (step S182), the representative color extracting unit 11 performs the process of extracting the representative colors for each of subject and background (step S188).

(i) Operation of Extracting Representative Colors from Image Data

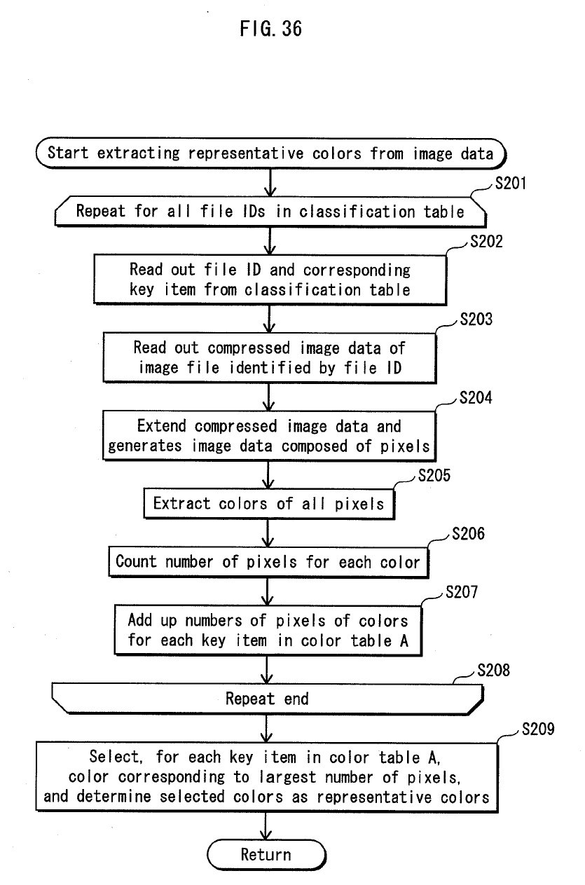

Here, a detailed description is given of the operation of extracting representative colors from image data, performed in step S185 of FIG. 35, with reference to the flowchart shown in FIG. 36.

The representative color extracting unit 11 repeats steps S202 through 5207 for each of all file IDs included in the classification table stored in the storage unit 19 (steps S201 through S208).

The representative color extracting unit 11 reads out a file ID and a key item corresponding to the file ID, from the classification table stored in the storage unit 19 (step S202), and reads out, from the recording device 5, compressed image data of the image file identified by the read-out file ID (step S203). The representative color extracting unit 11 then extends the read-out compressed image data and generates image data that is composed of a plurality of pixels (step S204). The representative color extracting unit 11 then extracts colors of all the pixels from the generated image data (step S205), and counts the number of pixels for each color (step S206). The representative color extracting unit 11 then, in the color table A 510 shown in FIG. 23, adds up the numbers of pixels of the colors for each key item (step S207).

When the performance of steps S202 through S207 is repeated for each of all file IDs included in the classification table stored in the storage unit 19, the representative color extracting unit 11 selects, for each key item in the color table A 510, a color that corresponds to the largest number of pixels, determines the selected colors as the representative colors, and sets the data item “selection” of each selected color to “1”, in the color table A 510 (step S209).

(ii) Operation of Determining Representative Colors from Tags

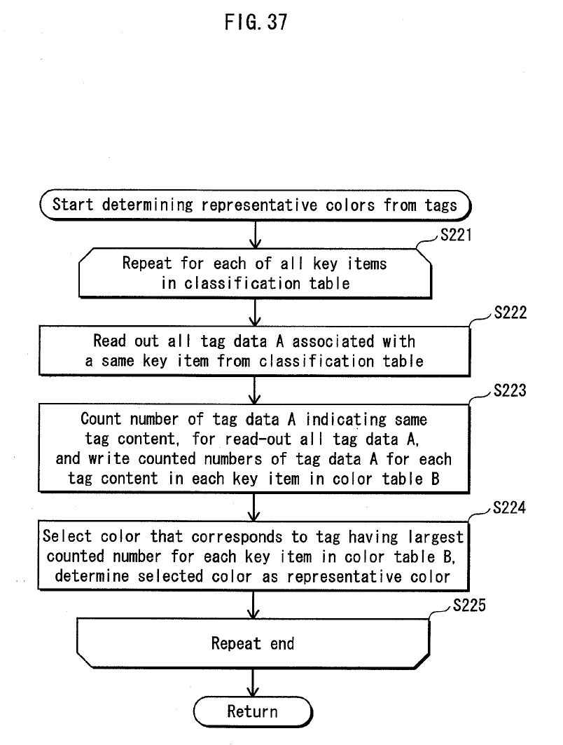

Here, a detailed description is given of the operation of determining representative colors from tags, performed in step S184 of FIG. 35, with reference to the flowchart shown in FIG. 37.

The representative color extracting unit 11 repeats steps S222 through 5224 for each of all key items included in the classification table stored in the storage unit 19 (steps S221 through S225).

The representative color extracting unit 11 reads out all pieces of tag data A that are associated with a same key item, from the classification table (steps S222). The representative color extracting unit 11 then counts the number of pieces of tag data A that indicate the same tag content, for the read-out all pieces of tag data A, and writes the counted numbers of pieces of tag data A for each tag content in each key item in the color table B 520 shown in FIG. 24 (steps S223). The representative color extracting unit 11 then selects a color that corresponds to a tag having the largest counted number for each key item in the color table B 520, determines the selected color as the representative color, and sets the data item “selection” of each selected color to “1”, in the color table B 520 (steps S224).

(iii) Operation of Extracting Representative Colors from Extraordinary Image Data

Here, a detailed description is given of the operation of extracting representative colors from extraordinary image data, performed in step S186 of FIG. 35, with reference to the flowchart shown in FIG. 38.

The representative color extracting unit 11 repeats the following steps S202a through 5207 for each of the file IDs included in the classification table stored in the storage unit 19 (steps S201 through S208).

The representative color extracting unit 11 reads out a file ID associated with the extraordinary and a key item corresponding to the file ID, from the classification table stored in the storage unit 19 (step S202a), and reads out, from the recording device 5, compressed image data of the image file identified by the read-out file ID (step S203). The representative color extracting unit 11 then extends the read-out compressed image data and generates image data that is composed of a plurality of pixels (step S204), extracts colors of all the pixels from the generated image data (step S205), and counts the number of pixels for each color (step S206). The representative color extracting unit 11 then, in the color table A 510 shown in FIG. 23, adds up the counted numbers of pixels of the colors for each key item (step S207).

When the performance of steps S202a through 5207 is repeated for each of all file IDs included in the classification table stored in the storage unit 19, the representative color extracting unit 11 selects, for each key item in the color table A 510, a color that corresponds to the largest number of pixels, determines the selected colors as the representative colors, and sets the data item “selection” of each selected color to “1”, in the color table A 510 (step S209).

(iv) Operation of Extracting Representative Colors from Each of Ordinary and Extraordinary Image Data

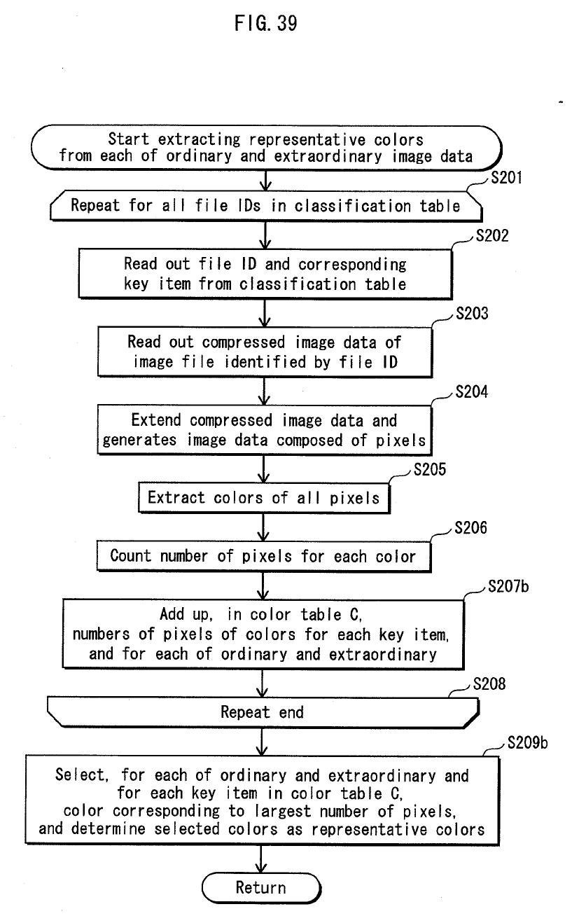

Here, a detailed description is given of the operation of extracting representative colors from each of ordinary and extraordinary image data, performed in step S187 of FIG. 35, with reference to the flowchart shown in FIG. 39.

The representative color extracting unit 11 repeats the following steps S202 through S207b for each of the file IDs included in the classification table stored in the storage unit 19 (steps S201 through S208).

The representative color extracting unit 11 reads out a file ID and a key item corresponding to the file ID, from the classification table stored in the storage unit 19 (step S202), and reads out, from the recording device 5, compressed image data of the image file identified by the read-out file ID (step S203). The representative color extracting unit 11 then extends the read-out compressed image data and generates image data that is composed of a plurality of pixels (step S204), extracts colors of all the pixels from the generated image data (step S205), and counts the number of pixels for each color (step S206). The representative color extracting unit 11 then, in the color table C 530 shown in FIG. 25, adds up the counted numbers of pixels of the colors for each key item, and for each of the ordinary and the extraordinary (step S207b).

When the performance of steps S202 through S207b is repeated for each of all file IDs included in the classification table stored in the storage unit 19, the representative color extracting unit 11 selects, for each of ordinary and extraordinary and for each key item in the color table C 530, a color that corresponds to the largest number of pixels, determines the selected colors as the representative colors, and sets the data item “selection” of each selected color to “1”, in the color table C 530 (step S209b).

(v) Operation of Extracting Representative Colors from Image Data for Each of Subject and Background

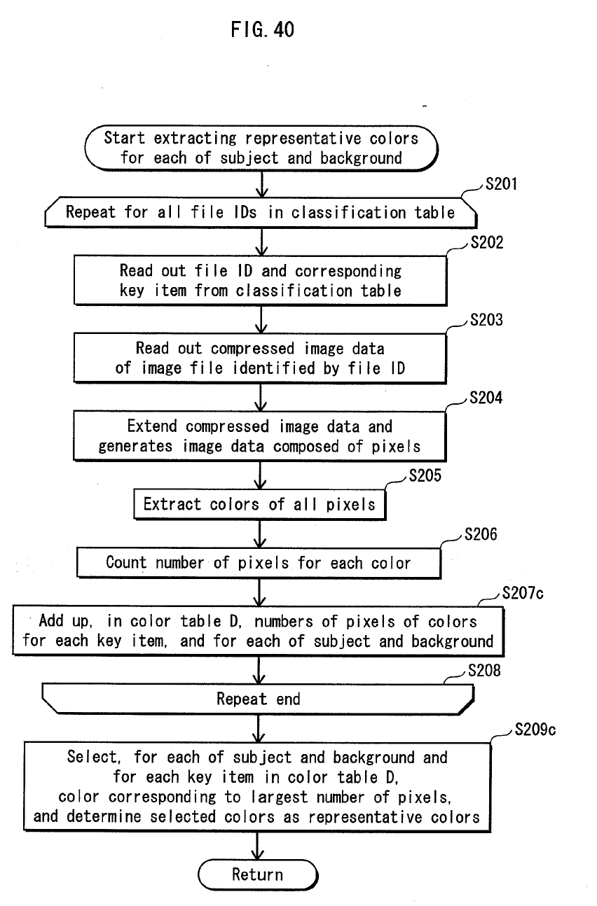

Here, a detailed description is given of the operation of extracting representative colors from image data for each of subject and background, performed in step S188 of FIG. 35, with reference to the flowchart shown in FIG. 40.

The representative color extracting unit 11 repeats the following steps S202 through S207c for each of the file IDs included in the classification table stored in the storage unit 19 (steps S201 through S208).

The representative color extracting unit 11 reads out a file ID and a key item corresponding to the file ID, from the classification table stored in the storage unit 19 (step S202), and reads out, from the recording device 5, compressed image data of the image file identified by the read-out file ID (step S203). The representative color extracting unit 11 then extends the read-out compressed image data and generates image data that is composed of a plurality of pixels (step S204), extracts colors of all the pixels from the generated image data (step S205), and counts the number of pixels for each color (step S206). The representative color extracting unit 11 then, in the color table D 540 shown in FIG. 26, adds up the counted numbers of pixels of the colors for each key item, and for each of subject and background (step S207c).

When the performance of steps S202 through S207c is repeated for each of all file IDs included in the classification table stored in the storage unit 19, the representative color extracting unit 11 selects, for each of subject and background and for each key item in the color table D 540, a color that corresponds to the largest number of pixels, determines the selected colors as the representative colors, and sets the data item “selection” of each selected color to “1”, in the color table D 540 (step S209c).

(6) Operation of Laying Out Representative Colors

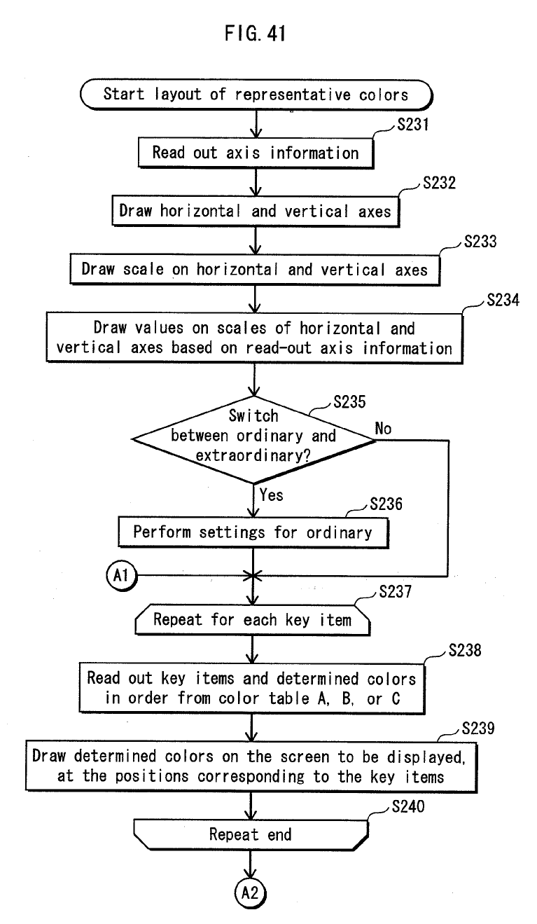

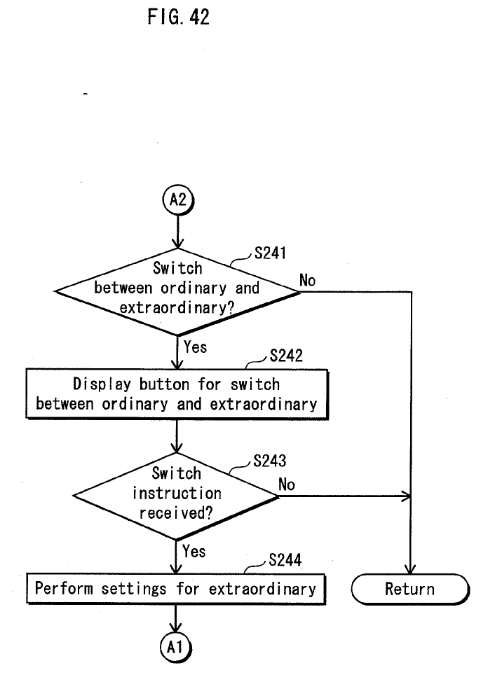

Here, a detailed description is given of the operation of laying out representative colors, performed in step S107 of FIG. 31, with reference to the flowcharts shown in FIGS. 41 and 42.

The representative color layout unit 12 reads out axis information from the storage unit 19 (step S231), draws the horizontal and vertical axes on a screen to be displayed (step S232), draws the scale on the horizontal and vertical axes (step S233), and, based on the read-out axis information, draws values on the scales of the horizontal and vertical axes (step S234).

Next, the representative color switching unit 16 judges whether the switch between the ordinary state and the extraordinary state is stored in the storage unit 19. When the switch is stored in the storage unit 19 (step S235), the representative color switching unit 16 sets an initial value inside to display the ordinary state, and instructs the representative color layout unit 12 to display the ordinary state (step S236).

Next, the representative color layout unit 12 repeats the following steps S238 through S239 for each key item included in the color table stored in the storage unit 19 (steps S237 through S240).

The representative color layout unit 12 reads out, from the color table (the color table A, B, or C) stored in the storage unit 19, key items and determined colors in order. Here, when it receives an ordinary state display instruction from the representative color switching unit 16, the representative color layout unit 12 uses colors that are indicated as representative colors by the data item “selection for ordinary” in the color table C, based on the received ordinary state display instruction; and when it receives an extraordinary state display instruction from the representative color switching unit 16, the representative color layout unit 12 uses colors that are indicated as representative colors by the data item “selection for extraordinary” in the color table C, based on the received extraordinary state display instruction (step S238). Next, the representative color layout unit 12 draws the determined colors on the screen to be displayed, at the positions corresponding to the key items (step S239).

When the performance of steps S238 through S239 is repeated by the representative color layout unit 12 for all key items included in the color table stored in the storage unit 19, the representative color switching unit 16 judges whether there is a switch between the ordinary state and the extraordinary state. When there is not a switch (step S241), the representative color layout unit 12 ends the processing.

When there is a switch between the ordinary state and the extraordinary state (step S241), the representative color switching unit 16 controls the display unit 17 to display, on the screen, a button for a switch between the ordinary state and the extraordinary state. The display unit 17 displays the button on the screen (step S242). The representative color switching unit 16 waits for a switch instruction to be input by the user. When it receives the switch instruction (step S243), the representative color switching unit 16 switches from the current setting to the other setting, namely, from “ordinary” to “extraordinary”, or from “extraordinary” to “ordinary”. When it switches the setting to “extraordinary”, the representative color switching unit 16 instructs the representative color layout unit 12 to perform for “extraordinary”, and when it switches the setting to “ordinary”, the representative color switching unit 16 instructs the representative color layout unit 12 to perform for “ordinary” (step S244), and then controls the representative color layout unit 12 to return to step S237 to repeat the process.

When the representative color switching unit 16 waits for a switch instruction to be input by the user and there is no input of the switch instruction (step S243), the representative color layout unit 12 ends the processing.

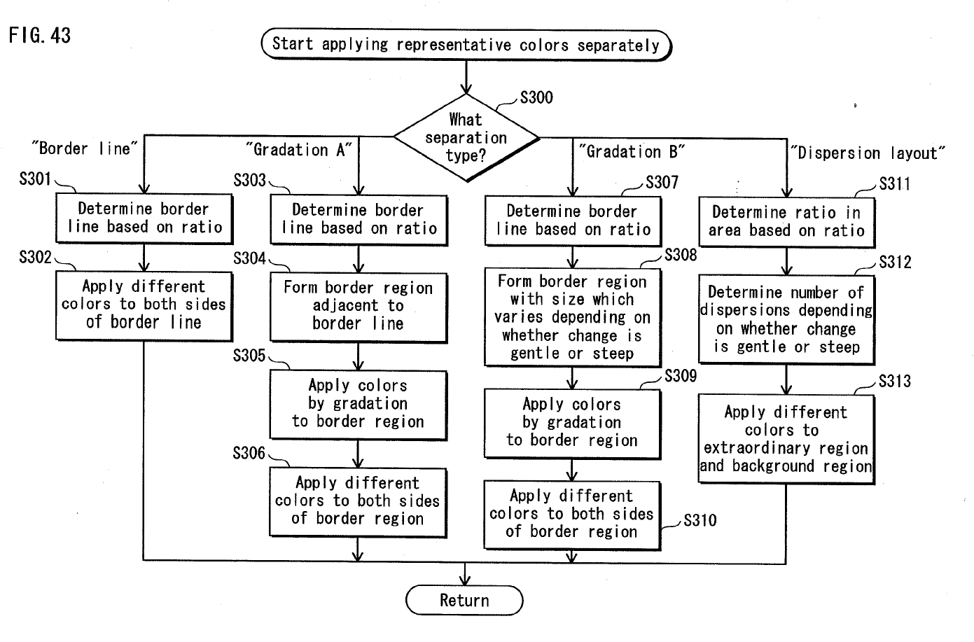

Now, a description is given of the operation of applying representative colors separately by the representative color layout unit 12, which is performed in step S239 of FIG. 41, with reference to the flowchart shown in FIG. 43.

The representative color layout unit 12 reads out the separation type from the storage unit 19. When the read-out separation type is “border line” (step S300), the representative color layout unit 12 determines a drawing position of the border line in the display unit region based on a ratio between the number of images shot in the ordinary state and the number of images shot in the extraordinary state (step S301). The representative color layout unit 12 then applies different colors to both sides of the border line in the display unit region, respectively (step S302).

When the read-out separation type is “gradation A” (step S300), the representative color layout unit 12 determines a drawing position of the border line in the display unit region based on a ratio between the number of images shot in the ordinary state and the number of images shot in the extraordinary state (step S303). The representative color layout unit 12 then forms a border region to have a predetermined width on either side of the border line (step S304), applies colors by gradation to inside the border region (step S305), and applies different colors to both sides of the border region in the display unit region, respectively (step S306).

When the read-out separation type is “gradation B”, the representative color layout unit 12 determines a drawing position of the border line in the display unit region based on a ratio between the number of images shot in the ordinary state and the number of images shot in the extraordinary state (step S307). The representative color layout unit 12 then forms a border region to have a predetermined width on either side of the border line, where each width of the border region varies depending on whether the change between the images shot in the ordinary state and the images shot in the extraordinary state is gentle or steep (step S308). The representative color layout unit 12 then applies colors by gradation to inside the border region (step S309), and applies different colors to both sides of the border region in the display unit region, respectively (step S310).

When the read-out separation type is “dispersion layout” (step S300), the representative color layout unit 12 determines a ratio in area between the background region and the extraordinary region in the display unit region, in accordance with a ratio between the number of images shot in the ordinary state and the number of images shot in the extraordinary state (step S311). The representative color layout unit 12 determines the number of dispersions depending on whether the change between the images shot in the ordinary state and the images shot in the extraordinary state is gentle or steep (step S312). The representative color layout unit 12 then applies different colors to the background region and the extraordinary region in the display unit region, respectively (step S313).

### 4. SUMMARY

As described above, one aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; and a shooting date/time obtaining unit operable to obtain shooting dates/times from shooting date/time information which has been embedded in images or has been recorded in association with images, wherein the image classifying unit classifies the plurality of images into the one or more image groups which respectively belong to predetermined periods, based on the obtained shooting dates/times, and the representative color layout unit lays out the representative colors in association with the predetermined periods.

In the above-stated image browsing device, the representative color layout unit may lay out the representative colors two dimensionally, with a vertical axis and a horizontal axis being respectively associated with an upper time unit and a lower time unit.

Another aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; and an ordinary/extraordinary setting unit operable to set, in each image, a distinction between an ordinary state and an extraordinary state in which the image was shot, wherein the representative color extracting unit extracts a representative color either from images set to ordinary or from images set to extraordinary, among the images included in the image groups.

In the above-stated image browsing device, the representative color extracting unit may extract the representative color only from the images set to extraordinary.

In the above-stated image browsing device, the representative color extracting unit may extract a first representative color from the images set to ordinary, and extract a second representative color from the images set to extraordinary, and the representative color layout unit may separately display the first representative color and the second representative color.

In the above-stated image browsing device, the representative color extracting unit may extract a first representative color from the images set to ordinary, and extract a second representative color from the images set to extraordinary, and the representative color layout unit display the first representative color or the second representative color, one at a time by switching between the first representative color and the second representative color.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; a display mode managing unit operable to set and manage a switch among display modes in which images are laid out and displayed; and a representative color switching unit operable to switch among methods for determining a representative color, depending on a display mode to which the display mode managing unit has switched, wherein the representative color extracting unit extracts a representative color by a method to which the representative color switching unit has switched.

In the above-stated image browsing device, the display mode managing unit may set and manage a switch between (i) a mode in which images are laid out on a time axis and (ii) a mode in which images are laid out based on additional information that is associated with each image.

In the above-stated image browsing device, the representative color extracting unit may extract a main color of images targeted for extracting the representative color included in each image group, as the representative color.

The above-stated image browsing device may further include a color correlation managing unit operable to manage additional information and colors in correlation with each other, the additional information being associated with images, and the representative color extracting unit may extract, as the representative color, a color that is correlated by the color correlation managing unit with apiece of additional information that has a largest number of associations with images targeted for extracting the representative color included in the image group.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; and a representative color layout unit operable to lay out the representative colors extracted by the representative color extracting unit and display the laid-out colors, wherein the representative color extracting unit extracts a plurality of representative colors corresponding to a plurality of conditions as representative colors, and the representative color layout unit lays out the representative colors by applying the representative colors separately for the conditions.

In the above-stated image browsing device, the representative color layout unit may apply the representative colors separately in accordance with a ratio among the numbers of images that respectively satisfy the plurality of conditions, among the images included in the image group.

In the above-stated image browsing device, the representative color layout unit may apply the representative colors separately so that the plurality of representative colors gradually change, and may adjust a level of the gradual change of the colors depending on a distribution of the images which respectively satisfy the plurality of conditions, among the images included in the image group.

In the above-stated image browsing device, the representative color layout unit may render variable a pattern of applying the representative colors separately, depending on a distribution of the images which respectively satisfy the plurality of conditions, among the images included in the image group.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; and a representative color layout unit operable to lay out the representative colors extracted by the representative color extracting unit and display the laid-out colors, wherein the representative color extracting unit extracts a plurality of colors corresponding to a plurality of conditions as representative colors, and the representative color layout unit displays the representative colors by switching among the representative colors.

In the above-stated image browsing device, the representative color layout unit may render variable a pattern of switching among the representative colors, depending on a distribution of the images which respectively satisfy the plurality of conditions, among the images included in the image group.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; and a representative color layout unit operable to lay out the representative colors extracted by the representative color extracting unit and display the laid-out colors, wherein the representative color extracting unit determines the representative colors by combining representative colors by assigning a plurality of pieces of information regarding the image group to different color components of a predetermined color system.

In the above-stated image browsing device, the predetermined color system may be a color system composed of hue, luminance, and saturation, and the color extracting unit determines the representative colors by combining the representative colors by assigning each of the plurality of pieces of information regarding the image group to any of hue, luminance, and saturation.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; a reduced image generating unit operable to generate reduced images by reducing images; a reduced image layout unit operable to lay out the reduced images generated by the reduced image generating unit and display the laid-out reduced images; a browsing range setting unit operable to set a browsing range that indicates a range of images being targets of browsing; and a browsing mode switching unit operable to switch between a display by the color layout unit and a display by the reduced image layout unit, depending on the browsing range set by the browsing range setting unit.

In the above-stated image browsing device, the browsing mode switching unit may switch between the display by the color layout unit and the display by the reduced image layout unit, depending on whether or not the number of images included in the browsing range set by the browsing range setting unit is equal to or larger than a predetermined number.

In the above-stated image browsing device, the browsing mode switching unit may switch between the display by the color layout unit and the display by the reduced image layout unit, depending on whether shooting dates/times of images included in the browsing range set by the browsing range setting unit are included in a predetermined time period.

With the above-described structure, in addition to extracting a representative color for each image group so that the image groups, into which images have been classified according to a predetermined criterion, can be represented by the representative colors, it is possible to lay out the representative colors in correspondence with predetermined periods into which images have been classified according to the shooting dates/times of the images. This makes it easy for users to grasp the change in contents of images for each particular period, such as each year.

The structure also makes it possible to set, in each image, whether the image was shot in an ordinary state or in an extraordinary state, and extract representative colors from images shot in either of the states. This makes it easier to browse and grasp the contents of images shot in the ordinary state or the extraordinary state.

Also, with the structure where the methods for determining the representative colors are switched depending on the switch between the image display modes, appropriate representative colors that are suited to the browsing state can be displayed.

Further, with the structure where a plurality of representative colors corresponding to a plurality of conditions are extracted and displayed, or with the structure where the representative colors are combined by assigning a plurality of pieces of information to different color components of a predetermined color system and the representative colors are displayed, it is possible to, while representing a lot of images by colors, display a larger amount of information than the case where a piece of information is simply represented by a single color.

Further, with the structure where the display of representative colors and the display of reduced images are switched depending on the range of the browsing-target images, it is possible for users to browse images with a more appropriate display reflecting the amount of browsing-target images.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; and a shooting date/time obtaining unit operable to obtain shooting dates/times from shooting date/time information which is either embedded in each image or recorded in association with each image, wherein the image classifying unit classifies the images into one or more image groups each having a predetermined time period, based on the shooting dates/times obtained by the shooting date/time obtaining unit, and the representative color layout unit lays out the representative colors in correspondence with the predetermined time period.

In the above-stated image browsing device, the representative color layout unit may lay out the representative colors two-dimensionally on a plane that is composed of a vertical axis and a horizontal axis which respectively correspond to elapses of time, at positions corresponding to time periods to which each image group corresponds.

A further aspect of the present invention is an image browsing device including: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; and an ordinary/extraordinary setting unit operable to set in each image either an ordinary state or an extraordinary state in accordance with a state in which each image was shot, wherein the representative color extracting unit extracts representative colors from images shot in either the ordinary state or the extraordinary state, among the images included in the image group.

In the above-stated image browsing device, the representative color extracting unit may extract representative colors only from images shot in the extraordinary state.

In the above-stated image browsing device, the color extracting unit may extract a first representative color from images shot in the ordinary state, and extracts a second representative color from images shot in the extraordinary state, and the color layout unit lays out the representative colors by applying the first representative color and the second representative color separately.

In the above-stated image browsing device, the color extracting unit may extract a first representative color from images shot in the ordinary state, and extracts a second representative color from images shot in the extraordinary state, and the color layout unit lays out the first representative color and the second representative color by switching therebetween.

A further aspect of the present invention includes: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; a display mode managing unit operable to manages switch among a plurality of display modes which respectively indicate a plurality of methods for laying out and displaying each image; and a representative color switching unit operable to switch among methods for determining representative colors, depending on a display mode set by the display mode managing unit, wherein the representative color extracting unit extract representative colors in accordance with a representative color determining method set by switching by the representative color switching unit.

In the above-stated aspect of the present invention, one of the plurality of methods for laying out and displaying each image may be a method by which images are laid out and displayed based on a time axis, and another one of the plurality of methods for laying out and displaying each image may be a method by which images are laid out and displayed based on additional information associated with images, and the display mode managing unit may switch between a mode in which images are laid out and displayed based on a time axis, and a mode in which images are laid out and displayed based on additional information associated with images.

In the above-stated aspect of the present invention, the representative color extracting unit may extract, as a representative color, a main color among images targeted for extracting representative color, included in the image group.

The above-stated aspect of the present invention may further include a color correlation managing unit operable to manage additional information and colors in correlation with each other, the additional information being associated with images, and the representative color extracting unit may extract, as the representative color, a color that is correlated by the color correlation managing unit with a piece of additional information that has a largest number of associations with images targeted for extracting the representative color included in the image group.

A further aspect of the present invention includes: an image classifying unit operable to classify a plurality of images into one or more image groups based on a predetermined criterion; a representative color extracting unit operable to extract a representative color for each of the image groups obtained by the image classifying unit; and a representative color layout unit operable to lay out the representative colors extracted by the representative color extracting unit and display the laid-out colors, wherein the representative color extracting unit extracts a plurality of colors corresponding to a plurality of conditions as representative colors, and the representative color layout unit displays the representative colors separately.

In the above-stated aspect of the present invention, the representative color layout unit may lay out the representative colors by applying the representative colors separately, in accordance with a ratio in number among images which respectively satisfy the plurality of conditions, among the images included in the image group.

In the above-stated aspect of the present invention, the representative color layout unit may lay out the representative colors by applying the representative colors separately such that the representative colors gradually change, and adjust a level of the gradual change of the colors depending on a distribution of the images which respectively satisfy the plurality of conditions.

In the above-stated aspect of the present invention, the representative color layout unit may render variable a pattern of applying the representative colors separately, depending on a distribution of the images which respectively satisfy the plurality of conditions, among the images included in the image group.

A further aspect of the present invention includes: an image classifying unit operable to classify a plurality of images into one or more image groups based on a predetermined criterion; a representative color extracting unit operable to extract a representative color for each of the image groups obtained by the image classifying unit; and a representative color layout unit operable to lay out the representative colors extracted by the representative color extracting unit and display the laid-out colors, wherein the representative color extracting unit extracts a plurality of colors corresponding to a plurality of conditions as representative colors, and the representative color layout unit displays the representative colors by switching therebetween.

In the above-stated aspect of the present invention, the representative color layout unit may render variable a pattern of applying the representative colors separately, depending on a distribution of the images which respectively satisfy the plurality of conditions, among the images included in the image group.

A further aspect of the present invention includes: an image classifying unit operable to classify a plurality of images into one or more image groups based on a predetermined criterion; a representative color extracting unit operable to extract a representative color for each of the image groups obtained by the image classifying unit; and a representative color layout unit operable to lay out the representative colors extracted by the representative color extracting unit and display the laid-out colors, wherein the representative color extracting unit determines the representative colors by combining representative colors by assigning a plurality of pieces of information regarding the image group to different color components of a predetermined color system.

In the above-stated aspect of the present invention, the predetermined color system may be a color system composed of hue, luminance, and saturation, and the color extracting unit determines the representative colors by combining the representative colors by assigning each of the plurality of pieces of information regarding the image group to any of hue, luminance, and saturation.

A further aspect of the present invention includes: an image classifying unit operable to classify a plurality of images into one or more image groups based on a predetermined criterion; a representative color extracting unit operable to extract a representative color for each of the image groups obtained by the image classifying unit; a representative color layout unit operable to lay out the representative colors extracted by the representative color extracting unit and display the laid-out colors; a reduced image generating unit operable to generate reduced images by reducing images; a reduced image layout unit operable to lay out the reduced images generated by the reduced image generating unit and display the laid-out reduced images; a browsing range setting unit operable to set a browsing range that indicates a range of images being targets of browsing; and a browsing mode switching unit operable to switch between a display by the color layout unit and a display by the reduced image layout unit, depending on the browsing range set by the browsing range setting unit.

In the above-stated aspect of the present invention, the browsing mode switching unit may switch between the display by the color layout unit and the display by the reduced image layout unit, depending on whether or not the number of images included in the browsing range set by the browsing range setting unit is equal to or larger than a predetermined number.

In the above-stated aspect of the present invention, the browsing mode switching unit may switch between the display by the color layout unit and the display by the reduced image layout unit, depending on whether shooting dates/times of images included in the browsing range set by the browsing range setting unit are included in a predetermined time period.

As described above, according to the image browsing device and method of the present invention, viewers can grasp efficiently and panoramically the contents of a large number of images which are displayed in a display area of a limited size.

### 5. OTHER MODIFICATIONS

Up to now, the present invention has been described through several embodiments thereof. However, the present invention is not limited to the embodiments, but can be applied to other modifications.

The present invention includes the following modifications, for example.

(1) Each of the above-described devices is specifically a computer system that includes a microprocessor, ROM, RAM, a hard disk unit, a display unit, a keyboard, a mouse and the like. A computer program is stored in the RAM or the hard disk unit. The computer program mentioned above is composed of a plurality of instruction codes which each instructs the computer to achieve a predetermined function. The microprocessor operates in accordance with the computer program and causes each device to achieve the functions. That is to say, the microprocessor reads out instructions included in the computer program, one by one, decodes the read-out instructions, and operate in accordance with the decoding results.

(2) Part or all of constituent elements constituting each of the above-described devices may be achieved in a system LSI (Large Scale Integration). The system LSI is an ultra multi-functional LSI that is manufactured by integrating a plurality of components on one chip. More specifically, the system LSI is a computer system that includes a microprocessor, ROM, RAM and the like. A computer program is stored in the RAM. The microprocessor operates in accordance with the computer program, thereby enabling the system LSI to achieve its functions.

Each part of constituent elements constituting each of the above-described devices may be achieved on one chip, or part or all thereof may be achieved on one chip. Although the term LSI is used here, it may be called IC, system LSI, super LSI, ultra LSI or the like, depending on the level of integration.

Also, the integrated circuit may not necessarily be achieved by the LSI, but may be achieved by the dedicated circuit or the general-purpose processor. It is also possible to use the FPGA (Field Programmable Gate Array), with which a programming is available after the LSI is manufactured, or the reconfigurable processor that can re-configure the connection or setting of the circuit cells within the LSI.

Furthermore, a technology for an integrated circuit that replaces the LSI may appear in the near future as the semiconductor technology improves or branches into other technologies. In that case, the new technology may be incorporated into the integration of the functional blocks constituting the present invention as described above. Such possible technologies include biotechnology.

(3) Part or all of the constituent elements constituting each of the above-described devices may be achieved as an IC card or a single module that is attachable/detachable to or from each device. The IC card or module is a computer system that includes a microprocessor, ROM, RAM, and the like. The IC card or module may include the aforesaid ultra multi-functional LSI. The microprocessor operates in accordance with the computer program and causes the IC card or module to achieve the functions. The IC card or module may be tamper resistant.

(4) The present invention may be methods shown by the above. The present invention may be a computer program that allows a computer to realize the methods, or may be digital signals representing the computer program.

Furthermore, the present invention may be a computer-readable recording medium such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the computer program or the digital signal recorded on any of the aforementioned recording mediums.

Furthermore, the present invention may be the computer program or the digital signal transmitted via an electric communication line, a wireless or wired communication line, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal via the recording medium, or by transferring the program or the digital signal via the network or the like, the program or the digital signal may be executed by another independent computer system.

(5) The present invention may be any combination of the above-described embodiments and modifications.

### INDUSTRIAL APPLICABILITY

The image browsing device of the present invention is useful as an image browsing device that has a function to represent and display a large amount of images by colors.

1. An image browsing device comprising:
an image obtaining unit operable to obtain a plurality of shot images;
an image classifying unit operable to classify the obtained shot images into a plurality of image groups according to a shooting time of each image such that images shot in a same period belong to a same image group;
a color extracting unit operable to extract, for each of the plurality of image groups, one or more representative colors representing the each of the plurality of image groups;
a color layout unit operable to lay out the extracted one or more representative colors, on a browsing screen at positions that are determined from periods corresponding to the representative colors; and
a screen display unit operable to display the browsing screen with the representative colors laid out thereon.

2. The image browsing device of claim 1, wherein
the browsing screen has a coordinate plane which is composed of a first axis and a second axis, the first axis corresponding to elapse of time in first time units, the second axis corresponding to elapse of time in second time units, the second time unit being obtained by segmentation of the first time unit, and
the color layout unit lays out the one or more representative colors in a region on the coordinate plane, the region corresponding to a first time unit to which the period corresponding to the representative color belongs, at a position corresponding to a second time unit to which the period belongs.

3. The image browsing device of claim 1, wherein
whether an image was shot in an ordinary state or in an extraordinary state has been set in each image obtained by the image obtaining unit, and
the color extracting unit extracts the one or more representative colors from either or both of images shot in the ordinary state and images shot in the extraordinary state, among images included in each image group.

4. The image browsing device of claim 3, wherein
the color extracting unit extracts the one or more representative colors from only images shot in the extraordinary state.

5. The image browsing device of claim 3, wherein
the color extracting unit extracts a first representative color from images shot in the ordinary state, and extracts a second representative color from images shot in the extraordinary state, and
the color layout unit lays out the first and second representative colors on the browsing screen by applying the first and second representative colors separately at the position.

6. The image browsing device of claim 3, wherein
the color extracting unit extracts a first representative color from images shot in the ordinary state, and extracts a second representative color from images shot in the extraordinary state, and
the color layout unit lays out the first representative color and the second representative color one at a time on the browsing screen by switching therebetween at the position.

7. The image browsing device of claim 1, wherein
the color extracting unit includes:
a storage unit storing one of a plurality of display modes which respectively indicate a plurality of methods of arranging and displaying each image;
a switching unit operable to switch between methods of determining representative colors depending on the display mode stored in the storage unit; and
an extracting unit operable to extract the one or more representative colors for each image group depending on a method of determining representative colors that has been set as a result of the switching performed by the switching unit.

8. The image browsing device of claim 7, wherein
one of the plurality of methods of arranging and displaying each image is a method by which images are arranged and displayed based on a time axis, and another one of the plurality of methods of arranging and displaying each image is a method by which images are arranged and displayed based on additional information associated with the images,
the storage unit stores one of a first display mode and a second display mode, wherein in the first display mode, images are laid out and displayed based on the time axis, and in the second display mode, images are laid out and displayed based on the additional information associated with the images,
the switching unit in the first display mode switches to a method of determining, as the one or more representative colors, one or more colors that correspond to a largest number of pieces of additional information among images constituting an image group, and in the second display mode switches to a method of determining, as the one or more representative colors, a color that is a main color among the images constituting the image group, and
the extracting unit extracts the one or more representative colors by the method of determining a color that corresponds to additional information, or by the method of determining a color that is a main color among the images constituting the image group.

9. The image browsing device of claim 1, wherein
the color extracting unit extracts, as the one or more representative colors, a main color of images targeted for extracting representative colors among the images constituting the image group.

10. The image browsing device of claim 1, wherein
each image obtained by the image obtaining unit is associated with additional information,
the image browsing device further comprises:
a storage unit storing the additional information and colors associated therewith, and
the color extracting unit extracts, as the one or more representative colors, a color that is associated with a largest number of pieces of additional information, among images targeted for extracting representative colors among the images constituting the image group.

11. The image browsing device of claim 1, wherein
the color extracting unit extracts, as representative colors, a plurality of colors in correspondence with a plurality of conditions, and
the color layout unit lays out the representative colors by applying the representative colors separately.

12. The image browsing device of claim 11, wherein
the color layout unit lays out the representative colors by applying the representative colors separately at the position, in accordance with a ratio of the number of images among images which respectively satisfy the plurality of conditions, among the images included in the image group.

13. The image browsing device of claim 11, wherein
the color layout unit lays out the representative colors by applying the representative colors separately such that the representative colors gradually change from a first color to a second color among the plurality of representative colors, and adjust a level of the gradual change of the colors depending on a distribution of the images which respectively satisfy the plurality of conditions.

14. The image browsing device of claim 11, wherein
the color layout unit changes patterns of applying separately the plurality of representative colors, depending on a distribution of the images which respectively satisfy the plurality of conditions, among the images included in the image group.

15. The image browsing device of claim 1, wherein
the color extracting unit extracts, as the one or more representative colors, a plurality of colors which respectively satisfy a plurality of conditions, and
the color layout unit lays out the plurality of representative colors one at a time by switching thereamong.

16. The image browsing device of claim 15, wherein
the color layout unit changes patterns of applying the plurality of representative colors by switching, depending on a distribution of the images which respectively satisfy the plurality of conditions, among the images included in the image group.

17. The image browsing device of claim 1, wherein
the color extracting unit extracts the representative colors by generating representative colors by assigning each of the plurality of pieces of information regarding the image groups to different color components of a predetermined color system.

18. The image browsing device of claim 17, wherein
the predetermined color system is a color system composed of hue, luminance, and saturation, and
the color extracting unit extracts the representative colors by generating representative colors by assigning each of the plurality of pieces of information regarding the image groups to hue, luminance, and saturation.

19. The image browsing device of claim 1 further comprising:
an image generating unit operable to generate reduced images by reducing each of the obtained plurality of images;
an image layout unit operable to lay out the generated reduced images on the browsing screen;
a range setting unit operable to set a browsing range that indicates a range of images being targets of browsing; and
a layout switching unit operable to switch between a layout by the color layout unit and a layout by the image layout unit, by using the browsing range set by the range setting unit, wherein
the screen display unit display the browsing screen with a layout set by the layout switching unit.

20. The image browsing device of claim 19, wherein
the layout switching unit switches between the layout by the color layout unit and the layout by the image layout unit, depending on whether the number of images included in the browsing range set by the range setting unit is equal to or smaller than a predetermined number.

21. The image browsing device of claim 19, wherein
the layout switching unit switches between the layout by the color layout unit and the layout by the image layout unit, depending on whether the shooting dates and times of images included in the browsing range set by the range setting unit are included in a predetermined time period.

22. An image browsing method for use in an image browsing device, the image browsing method comprising the steps of:
obtaining a plurality of shot images;
classifying the obtained shot images into a plurality of image groups according to a shooting time of each image such that images shot in a same period belong to a same image group;
extracting, for each of the plurality of image groups, one or more representative colors representing the each of the plurality of image groups;
laying out the extracted one or more representative colors, on a browsing screen at positions that are determined from periods corresponding to the representative colors; and
displaying the browsing screen with the representative colors laid out thereon.

23. A computer-readable recording medium on which a computer program for image browsing used in an image browsing device has been recorded, the computer program causing a computer to perform the steps of:
obtaining a plurality of shot images;
classifying the obtained shot images into a plurality of image groups according to a shooting time of each image such that images shot in a same period belong to a same image group;
extracting, for each of the plurality of image groups, one or more representative colors representing the each of the plurality of image groups;
laying out the extracted one or more representative colors, on a browsing screen at positions that are determined from periods corresponding to the representative colors; and
displaying the browsing screen with the representative colors laid out thereon.

24. A computer program for image browsing used in an image browsing device, the computer program causing a computer to perform the steps of:
obtaining a plurality of shot images;
classifying the obtained shot images into a plurality of image groups according to a shooting time of each image such that images shot in a same period belong to a same image group;
extracting, for each of the plurality of image groups, one or more representative colors representing the each of the plurality of image groups;
laying out the extracted one or more representative colors, on a browsing screen at positions that are determined from periods corresponding to the representative colors; and
displaying the browsing screen with the representative colors laid out thereon.
